(19) United States
(12) Patent Application Publication
(10) Pub. No.: US 2014/0079341 A1
(43) Pub. Date: Mar. 20, 2014

(54) IMAGE PROCESSING APPARATUS AND IMAGE PROCESSING METHOD

(71) Applicant: Panasonic Corporation, Osaka (JP)

(72) Inventor: Tomohide Ishigami, Osaka (JP)

(73) Assignee: Panasonic Corporation, Osaka (JP)

(21) Appl. No.: 14/116,473

(22) PCT Filed: Apr. 23, 2013
(86) PCT No.: PCT/JP13/02737

§ 371 Date: Nov. 8, 2013

(30) Foreign Application Priority Data
May 30, 2012 (JP) 2012-123599

(51) Int. Cl. G06K 9/03

(52) U.S. Cl. CPC G06K 9/03
USPC 382/309

(57) ABSTRACT

An image processing apparatus includes: an image obtaining unit which obtains an input image; a mask image obtaining unit which obtains a mask image indicating an unnecessary region in the input image; an image generation unit which (i) generates a first reversed image by performing, on a first region adjacent in a first direction to the unnecessary region, first processing for reversing and placing a first pixel group in a direction opposite the first direction, and (ii) generates a second reversed image by performing, on a second region adjacent in a second direction to the unnecessary region, second processing for reversing and placing a second pixel group in a direction opposite the second direction; and an image combining unit which generates a combined image by combining the first reversed image and the second reversed image which are generated by the image generation unit.

### TECHNICAL FIELD

The present invention relates to an image processing apparatus and an image processing technique for removing an image in a designated unnecessary region in a video. The present invention can be widely utilized in the field of information processing apparatuses for video and image such as digital video cameras, digital cameras, DVD recorders, and so on.

### BACKGROUND ART

When a stranger is unintentionally included in a family picture, or when, aside from buildings, a passerby is included in a picture of a sightseeing spot, there is a desire to remove, after a picture is taken, an unnecessary region from an image.

A conventional method for removing the unnecessary region is known in which the unnecessary region is preliminarily designated by a user, an area of the designated unnecessary region is determined, and a different processing is performed depending on the size of the area. Specifically, the unnecessary region is complemented based on the peripheral region (i) using an isotropic diffusion equation and an anisotropic diffusion equation, in combination, when the area of the unnecessary region is smaller than a threshold, and (ii) using an advection equation and a Navier-Stokes (NS) equation when the area is greater than or equal to the threshold, for preventing inadvertent blur in the texture (for example, see Patent Literature (PTL) 1).

### CITATION LIST

### Patent Literature

[PTL 1] Japanese Unexamined Patent Application Publication No. 2007-286734

### SUMMARY OF INVENTION

### Technical Problem

However, the technique disclosed in PTL 1 has a problem that a lot of calculation is required and thus it takes a long time for image processing, which makes it difficult to perform processing in a short time without an apparatus having large data processing capacity. In addition, when the area of the unnecessary region is large, the portion on which the image processing is performed becomes unnatural.

The present invention has been conceived to solve the above conventional problems, and has an object to provide an image processing apparatus capable of performing complement processing on unnecessary regions, with a reduced calculation amount and more naturally.

### Solution to Problem

In order to achieve the above object, an image processing apparatus according to an aspect of the present invention includes: an image obtaining unit configured to obtain an input image; an obtaining unit configured to obtain region information indicating an unnecessary region in the input image; an image generation unit configured to (i) generate a first reversed image by performing, on a first region adjacent in a first direction to the unnecessary region indicated by the region information, first processing for reversing at a boundary of the unnecessary region to place, in reverse order, a first pixel group in a direction opposite the first direction, the first processing being repeated in a direction orthogonal to the first direction, the first pixel group consisting of pixels continuously arranged in the first direction, for a first width in the first direction in the unnecessary region, and (ii) generate a second reversed image by performing, on a second region adjacent in a second direction to the unnecessary region, second processing for reversing at a boundary of the unnecessary region to place, in reverse order, a second pixel group in a direction opposite the second direction, the second processing being repeated in a direction orthogonal to the second direction, the second pixel group consisting of pixels continuously arranged in the second direction, for a second width in the second direction in the unnecessary region; and an image combining unit configured to generate a combined image by combining the first reversed image and the second reversed image which are generated by the image generation unit.

With this, the first reversed image and the second reversed image are generated by reversing the respective pixel groups from the respective boundaries of the unnecessary region. Therefore, the unnecessary region can be complemented at high speed and using a natural image including a component equivalent to the component of the texture around the unnecessary region.

It is to be noted that general or specific aspects of the above may be realized by a system, a method, an integrated circuit, a computer program, or a computer-readable recording medium such as a CD-ROM, and an arbitrary combination of a system, a method, an integrated circuit, a computer program, and a recording medium.

### Advantageous Effects of Invention

With the image processing apparatus and the image processing method according to the present invention, the unnecessary regions can be complemented with a reduced calculation amount and more naturally.

### BRIEF DESCRIPTION OF DRAWINGS

FIG. 1 shows a configuration of an image processing apparatus according to Embodiment 1.

FIG. 2 shows a flowchart of processing according to Embodiment 1.

FIG. 3 illustrates how to generate a first reversed image, a second reversed image, and a combined image, according to Embodiment 1.

FIG. 4 shows a graph of weight coefficient, and so on.

FIG. 5 shows an order of reversed image generation processing according to Embodiment 1.

FIG. 6 illustrates a flow from when an unnecessary region is set in an input image to when a combined image is displayed.

FIG. 7 illustrates an example of UI display.

FIG. 8 illustrates an example of UI display.

FIG. 9 illustrates how to perform the processing when an image different from a background image is present at a position close to the unnecessary region.

FIG. 10 illustrates how to perform the processing when an image different from a background image is present at a position close to the unnecessary region.

FIG. 11 shows a configuration of an image processing apparatus according to Embodiment 2.

FIG. 12 shows a flowchart of processing according to Embodiment 2.

FIG. 13 illustrates an example of a boundary peripheral region of a mask image when texture analysis is performed according to Embodiment 2.

FIG. 14 shows a histogram showing a frequency of an edge direction.

FIG. 15 illustrates how to generate a first reversed image, a second reversed image, and a combined image, according to Embodiment 2.

FIG. 16 shows a configuration of an image processing apparatus according to Embodiment 3.

FIG. 17 shows a flowchart of processing according to Embodiment 3.

FIG. 18 shows an example of region division result according to Embodiment 3.

FIG. 19 shows an order of processing performed by a conventional unnecessary object removing apparatus.

### DESCRIPTION OF EMBODIMENTS

### Embodiment 1

### [Underlying Knowledge Forming Basis of the Present Disclosure]

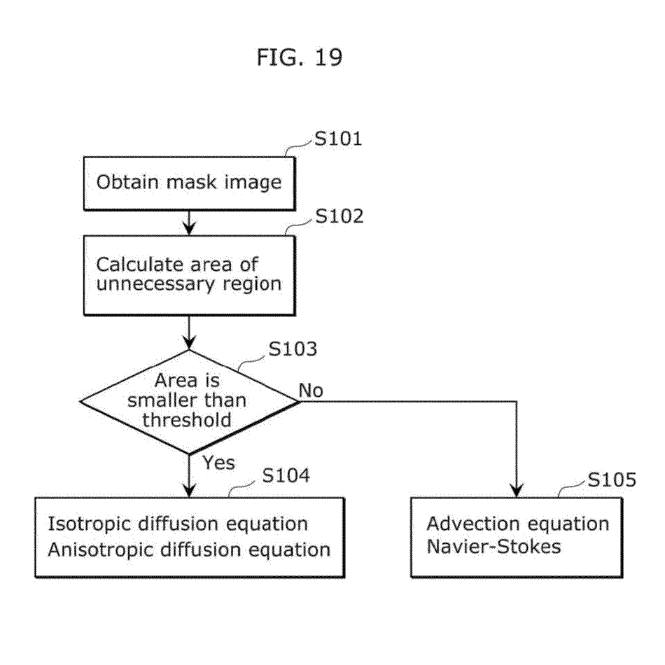

FIG. 19 shows a flow of image processing performed by the conventional unnecessary object removing apparatus disclosed in PTL 1.

In FIG. 19, an unnecessary region designated through a user interface (UI) such as a touch panel is converted into a mask image and obtained in S101. Next, an area of the unnecessary region indicated by the mask image is calculated in S102. Then, it is determined in S103 whether or not the area calculated in S102 is greater than or equal to a threshold. When the area of the unnecessary region is smaller than the threshold (S103: Yes), an isotropic diffusion equation and an anisotropic diffusion equation are used to perform unnecessary region complement processing for diffusing and propagating the pixels from the periphery of the unnecessary region to the unnecessary region (S104). Furthermore, when the area is greater than or equal to the threshold, an advection equation and an NS equation are used in combination, to diffuse and propagate the pixels in order to prevent blurs in the result of unnecessary region complement processing.

However, the conventional configuration has a problem that a large amount of calculation is required since the calculation is performed again and again using the diffusion equations and the advection equation and time propagation is performed. Furthermore, in the case where the NS equation is used, when the area of the unnecessary region is equal to or greater than a given range, the result of unnecessary region complement processing is different from the texture of the peripheral region, which ends up with blurs.

In order to achieve the above object, an image processing apparatus according to an aspect of the present invention includes: an image obtaining unit configured to obtain an input image; an obtaining unit configured to obtain region information indicating an unnecessary region in the input image; an image generation unit configured to (i) generate a first reversed image by performing, on a first region adjacent in a first direction to the unnecessary region indicated by the region information, first processing for reversing at a boundary of the unnecessary region to place, in reverse order, a first pixel group in a direction opposite the first direction, the first processing being repeated in a direction orthogonal to the first direction, the first pixel group consisting of pixels continuously arranged in the first direction, for a first width in the first direction in the unnecessary region, and (ii) generate a second reversed image by performing, on a second region adjacent in a second direction to the unnecessary region, second processing for reversing at a boundary of the unnecessary region to place, in reverse order, a second pixel group in a direction opposite the second direction, the second processing being repeated in a direction orthogonal to the second direction, the second pixel group consisting of pixels continuously arranged in the second direction, for a second width in the second direction in the unnecessary region; and an image combining unit configured to generate a combined image by combining the first reversed image and the second reversed image which are generated by the image generation unit.

With this, when the first pixel group is present in the first region in the first-direction side of the unnecessary region and the second pixel group is present in the second region in the second-direction side of the unnecessary region, the first reversed image and the second reversed image are generated by reversing the first pixel group and the second pixel group, respectively, at the boundaries of the unnecessary region. Therefore, the unnecessary region can be complemented at high speed and using a natural image including a component equivalent to the component of the texture around the unnecessary region.

Furthermore, the image generation unit may be configured to: (i) when it is determined that the number of the pixels continuously arranged in the first direction in the first region is smaller than the number of the pixels for the first width, obtain a pixel group consisting of pixels continuously arranged in the first direction in the first region, and generate the first reversed image by performing processing for repeatedly reversing and placing the pixel group in a direction opposite the first direction until the first width is satisfied, as the first processing, the first processing being repeated in a direction orthogonal to the first direction; and (ii) when it is determined that the number of the pixels continuously arranged in the first direction in the second region is smaller than the number of the pixels for the second width, obtain a pixel group consisting of pixels continuously arranged in the second direction in the second region, and generate the second reversed image by performing processing for repeatedly reversing and placing the pixel group in a direction opposite the second direction until the second width is satisfied, as the second processing, the second processing being repeated in a direction orthogonal to the second direction.

Therefore, even when the number of pixels around the unnecessary region is small, the unnecessary region can be complemented at high speed and using a natural image including a component equivalent to the component of the texture around the unnecessary region.

Furthermore, the image processing apparatus may further include a region setting unit configured to set a prohibited region, wherein the image generation unit may be configured to (i) generate the first reversed image by performing, on a region excluding the prohibited region out of the first region, the first processing repeatedly in the direction orthogonal to the first direction, when the prohibited region is in the first direction from the unnecessary region, and (ii) generate the second reversed image by performing, on a region excluding the prohibited region out of the second region, the second processing repeatedly in the direction orthogonal to the second direction, when the prohibited region is in the second direction from the unnecessary region.

With this, the first reversed image or the second reversed image can be generated by obtaining the first pixel group or the second pixel group, respectively, in the region excluding the prohibited region set by the region setting unit, Therefore, it is possible to prevent generation of the first reversed image or the second reversed image using texture obviously different from the texture around the unnecessary region. With this, the unnecessary region can be complemented using a natural image including a component equivalent to the component of the texture around the unnecessary region.

Furthermore, the image processing apparatus may further include a region setting unit configured to set a search region, wherein the image generation unit may be configured to (i) generate the first reversed image by performing the first processing on the search region repeatedly in the direction orthogonal to the first direction, and (ii) generate the second reversed image by performing the second processing on a region excluding the search region repeatedly in the direction orthogonal to the second direction.

With this, the first reversed image or the second reversed image can be generated by obtaining the first pixel group or the second pixel group, respectively, from the search region set by the region setting unit, Therefore, when the texture of the search region is set to be similar to the texture around the unnecessary region, the first reversed image or the second reversed image can be generated using the similar texture. With this, the unnecessary region can be complemented using a natural image including a component equivalent to the component of the texture around the unnecessary region.

Furthermore, the first direction may be a direction toward the left from the boundary of the unnecessary region in a horizontal direction, and the second direction may be a direction toward the right from the boundary of the unnecessary region in the horizontal direction.

With this, natural complement can be realized by reversing the pixels, since general images include a lot of horizontal components in the texture of the background region.

Furthermore, the image generation unit may be further configured to: (i) generate a third reversed image by performing, on a third region adjacent in a third direction, that is an upper direction in a vertical direction, to the unnecessary region, third processing for reversing at a boundary of the unnecessary region to place, in reverse order, a third pixel group in a direction opposite the third direction, the third processing being repeated in a direction orthogonal to the third direction, the third pixel group consisting of pixels continuously arranged in the third direction, for a third width in the third direction in the unnecessary region; and (ii) generate a fourth reversed image by performing, on a fourth region adjacent in a fourth direction, that is a lower direction in a vertical direction, to the unnecessary region, fourth processing for reversing at a boundary of the unnecessary region to place, in reverse order, a fourth pixel group in a direction opposite the fourth direction, the fourth processing being repeated in a direction orthogonal to the fourth direction, the fourth pixel group consisting of pixels continuously arranged in the fourth direction, for a fourth width in the fourth direction in the unnecessary region, and the image combining unit may be configured to generate a combined image by combining the first reversed image, the second reversed image, the third reversed image, and the fourth reversed image generated by the image generation unit.

With this, by reversing the texture of the vertical image included a lot in general images too, further natural combined images can be generated.

Furthermore, the image combining unit may be configured to perform the combination by multiplying pixel values of the respective pixels in the first reversed image by first weights set for the pixel values; multiplying pixel values of the respective pixels in the second reversed image by second weights set for the pixel values; and summing the respective pixel values multiplied by the first weights in the first reversed image and the respective pixel values multiplied by the second weights in the second reversed image. Specifically, the image combining unit may be configured to set each of the first weight and the second weight to increase for a pixel positioned closer to the boundary of the unnecessary region. Furthermore, the image combining unit may be configured to set the first weight and the second weight for the respective pixels included in the unnecessary region in a manner that a sum of (i) the first weight to be multiplied by a pixel value of a pixel at a position corresponding to the pixel in the first reversed image and (ii) the second weight to be multiplied by a pixel value of a pixel at a position corresponding to the pixel in the second reversed image is equal to 1.

With this, further natural images can be generated when combining the reversed image by reversing pixels from a plurality of directions.

Furthermore, the image processing apparatus may further include a texture analysis unit configured to analyze texture of a peripheral region of the unnecessary region to determine the first direction and the second direction. Specifically, the texture analysis unit may be configured to detect a highest-frequency line from edge strength and an edge angle which are obtained from an edge image of the input image, and determine the first direction and the second direction as both directions on the detected highest-frequency line. Furthermore, the texture analysis unit may be configured to detect a high-frequency angle from an edge angle per pixel or region which is obtained from the edge image of the input image, and determine the first direction and the second direction as a direction vertical to the high-frequency angle.

In many cases, the image captured by the user is not completely horizontal but is tilted. Therefore, the horizontal components in the background region are also displayed with tilted, Providing the texture analysis unit as in the above configuration allows detecting an angle of the tilt in the image and reflecting the result on the reverse direction. Therefore, further natural combined images can be generated.

Furthermore, the image processing apparatus may further include a region division unit configured to divide a peripheral region of the unnecessary region in the input image into a plurality of regions each being a group of pixels having same or similar features, wherein the image generation unit may be configured to generate a divided reversed image by performing, on the respective regions, processing for reversing at the boundary of the unnecessary region to place, in reverse order, a pixel group in a direction opposite a predetermined direction, the processing being repeated in a direction orthogonal to the predetermined direction, the pixel group consisting of pixels continuously arranged in the predetermined direction, for a predetermined width set in the region of the unnecessary region.

With this, the reverse direction is determined for the respective divided regions, by dividing the peripheral region according to the feature. Therefore, further natural combined images that match the texture of the background can be generated.

Furthermore, the image processing may further include an image display unit configured to display a result obtained from the image combining unit.

Furthermore, the image processing apparatus may be an image processing apparatus including a display unit configured to receive a touch input from a user, the apparatus including: a first detection unit configured to detect a region, which is identified through a first touch input made in an input image displayed on the display unit, as an unnecessary region in the input image; a second detection unit configured to detect a second touch input made after the detection of the unnecessary region by the first detection unit, and when the second touch input indicates a movement having a distance greater than or equal to a predetermined value, detect a direction of the movement as the first direction; an image generation unit configured to generate a first reversed image by performing, on a first region adjacent in the first direction to the unnecessary region, first processing for reversing at a boundary of the unnecessary region to place, in reverse order, a first pixel group in a direction opposite the first direction, the first processing being repeated in a direction orthogonal to the first direction, the first pixel group consisting of pixels continuously arranged in the first direction, for a first width in the first direction in the unnecessary region; an image combining unit configured to generate a combined image by combining the input image and the first reversed image; and the display unit configured to display the combined image.

With this, the image processing on the unnecessary region is performed based on the unnecessary region and the direction set through the touch input determined by the user. Therefore, the user can cause the image processing apparatus to perform the image processing based on conditions he/she desires.

It is to be noted that general or specific aspects of the above may be realized by a system, a method, an integrated circuit, a computer program, or a computer-readable recording medium such as a CD-ROM, and an arbitrary combination of a system, a method, an integrated circuit, a computer program, and a recording medium.

An image processing apparatus and an image processing method according to an aspect of the present invention is described below with reference to the Drawings.

It is to be noted that each of the embodiments described below is a specific example of the present invention. The numerical values, shapes, constituent elements, the arrangement and connection of the constituent elements, steps, the processing order of the steps etc, shown in the following embodiments are mere examples, and thus do not limit the present disclosure, Furthermore, out of the constituents in the following embodiments, the constituents not stated in the independent claims describing the broadest concept of the present invention are described as optional constituents.

### Embodiment 1

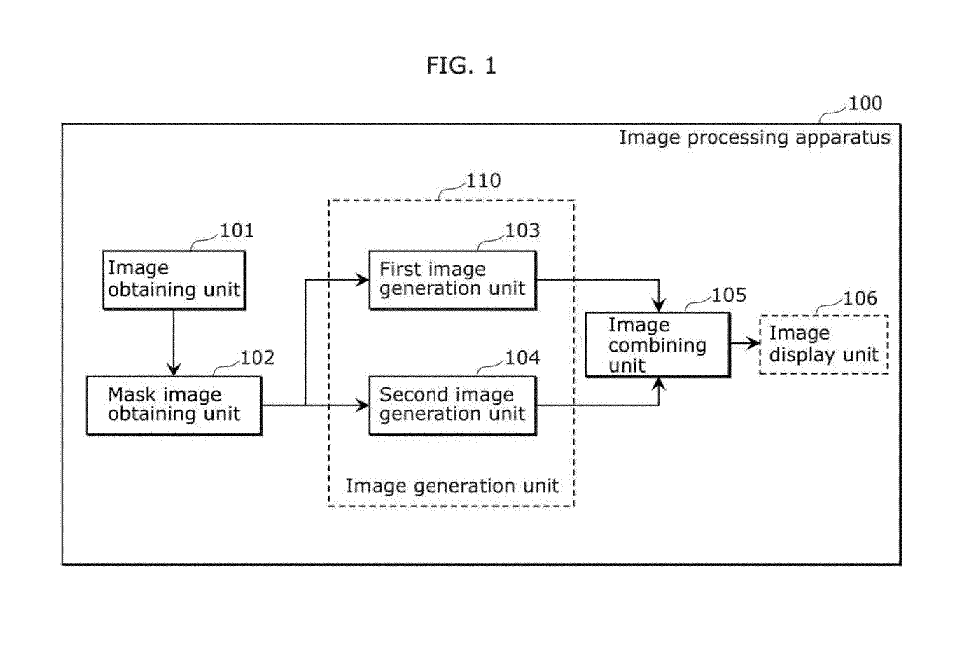

FIG. 1 shows a configuration of an image processing apparatus according to Embodiment 1 of the present invention. In FIG. 1, an image processing apparatus 100 according to the present invention includes: an image obtaining unit 101, a mask image obtaining unit 102, an image generation unit 110, and an image combining unit 105. The image generation unit 110 includes a first image generation unit 103 and a second image generation unit 104. Furthermore, the image processing apparatus 100 according to Embodiment 1 of the present invention may include an image display unit 106 as shown in FIG. 1.

Specifically, the image processing apparatus according to the present embodiment includes: an image obtaining unit configured to obtain an input image; an obtaining unit configured to obtain region information indicating an unnecessary region in the input image; an image generation unit configured to (i) generate a first reversed image by performing, on a first region adjacent in a first direction to the unnecessary region indicated by the region information, first processing for reversing at a boundary of the unnecessary region to place, in reverse order, a first pixel group in a direction opposite the first direction, the first processing being repeated in a direction orthogonal to the first direction, the first pixel group consisting of pixels continuously arranged in the first direction, for a first width in the first direction in the unnecessary region, and (ii) generate a second reversed image by performing, on a second region adjacent in a second direction to the unnecessary region, second processing for reversing at a boundary of the unnecessary region to place, in reverse order, a second pixel group in a direction opposite the second direction, the second processing being repeated in a direction orthogonal to the second direction, the second pixel group consisting of pixels continuously arranged in the second direction, for a second width in the second direction in the unnecessary region; and an image combining unit configured to generate a combined image by combining the first reversed image and the second reversed image which are generated by the image generation unit.

Description is provided below on each configuration according to the present embodiment.

The image obtaining unit 101 obtains an input image such as a still image and a moving image captured by a digital camera or a digital video camera, The image obtaining unit 101 transmits the obtained input image to the mask image obtaining unit 102.

The mask image obtaining unit 102 is an obtaining unit which obtains the input image transmitted from the image obtaining unit 101, and a mask image which indicates an unnecessary region designated by the user through the UI such as a touch panel for example. The mask image obtaining unit 102 transmits the obtained input image and the mask image to the first image generation unit 103 and the second image generation unit 104. The mask image is, for example, an image in which the unnecessary region is assigned with a luminance value of 255 and other region is assigned with a luminance value of 0 (binary image, for example). It is to be noted that the mask image obtaining unit 102 does not necessarily obtain the mask image as long as it obtains region information indicating the unnecessary region. Specifically, the mask image is included in the region information. Furthermore, the unnecessary region can be identified in various ways and how to identify the unnecessary region is not limited. For example, in the case where the region designated by the user through the UI such as the touch panel is determined as the unnecessary region, the unnecessary region may be designated by the user's touch to trace a boundary of a given region on the screen. Furthermore, the user may touch only a point on an image preliminarily divided into a plurality of regions, and the region including the touched pointed may be determined as the unnecessary region, Furthermore, in addition to the designation by the user, an algorithm may be provided for automatically detecting an unnecessary region according to a given standard preliminarily defined. For example, image processing or image recognition may be performed to detect the face or upper body, to detect a candidate for unnecessary region in advance in a face unit or person unit. Likewise, image processing etc, may be performed to detect a motion and the moving object may be detected as the candidate for an unnecessary region. In addition, a cluster unit having a similar color may be determined as a candidate for an unnecessary region through region division using the mean shift and so on.

The first image generation unit 103: obtains the input image and the mask image from the mask image obtaining unit 102 searches the pixels from the boundary of the unnecessary region (hereinafter referred to as “reverse boundary”) indicated by the mask image in the first direction; and reverses the searched pixels at the reverse boundary and places the searched pixels, to generate a first reversed image. After generating the first reversed image for use in complimenting the pixels in the unnecessary region, the first image generation unit 103 transmits the generated image to the image combining unit 105. The reverse boundary in the first image generation unit 103 (hereinafter referred to as “first reverse boundary”) is a boundary at which the unnecessary region can be obtained by searching in a first direction. Specifically, the first image generation unit 103 generates a first reversed image by performing, on a first region adjacent in a first direction to the unnecessary region indicated by the mask image (hereinafter referred to as “first search region”), first processing for reversing at a boundary of the unnecessary region to place, in reverse order, a first pixel group in a direction opposite the first direction, the first processing being repeated in a direction orthogonal to the first direction, the first pixel group consisting of pixels continuously arranged in the first direction, for a first width in the first direction in the unnecessary region (hereinafter referred to as “first search width”). More specifically, the first image generation unit 103 obtains a first pixel group consisting of pixels continuously arranged in line in the first direction and adjacent in the first direction to the unnecessary region, and places the pixels in the first pixel group, along the first direction, in reverse order and in a manner that a pixel closer to the first reverse boundary is placed to be closer to the boundary of the unnecessary region, on the unnecessary region.

The second image generation unit 104: obtains the input image and the mask image from the mask image obtaining unit 102; searches the pixels from the boundary of the unnecessary region indicated by the mask image in a second direction different from the first direction; and reverses the searched pixels at the reverse boundary and places the searched pixels, to generate a second reversed image. After generating the second reversed image for use in complimenting the pixels in the unnecessary region, the second image generation unit 104 transmits the generated image to the image combining unit 105. The reverse boundary in the second image generation unit 104 (hereinafter referred to as “second reverse boundary”) is a boundary at which the unnecessary region can be obtained by searching in the second direction. Specifically, the second image generation unit 104 generates a second reversed image by performing, on a second region adjacent in a second direction to the unnecessary region indicated by the mask image (hereinafter referred to as “second search region”), second processing for reversing at a boundary of the unnecessary region to place, in reverse order, a second pixel group in a direction opposite the second direction, the second processing being repeated in a direction orthogonal to the second direction, the second pixel group consisting of pixels continuously arranged in the second direction, for a second width in the second direction in the unnecessary region (hereinafter referred to as “second search width”). More specifically, the second image generation unit 104 obtains a second pixel group consisting of pixels continuously arranged in line in the second direction and adjacent in the second direction to the unnecessary region, and places the pixels in the second pixel group, along the second direction, in reverse order and in a manner that a pixel closer to the second reverse boundary is placed to be closer to the boundary of the unnecessary region, on the unnecessary region.

The image combining unit 105 obtains the first reversed image, the second reversed image, the input image, and the mask image, from the first image generation unit 103 and the second image generation unit 104. The image combining unit 105 generates a combined image through combination. The combined image is generated by weighting and combining the respective pixels in the first reversed image and the second reversed image according to the distances from the respective reverse boundaries, at which the reversing is performed, of the first reversed image and the second reversed image, respectively. Then, the image combining unit 105 transmits to the image display unit 106 the combined image of the obtained input image in which the unnecessary region has been complemented.

The image display unit 106 displays, on the liquid crystal display etc., the image combination result, in which the unnecessary region has been complemented, transmitted from the image combining unit 105. As described above, the image display unit 106 may be included in the image processing apparatus according to the present embodiment, or, in the case where the image processing apparatus does not include the display unit, the image combination result may be output to an external display unit.

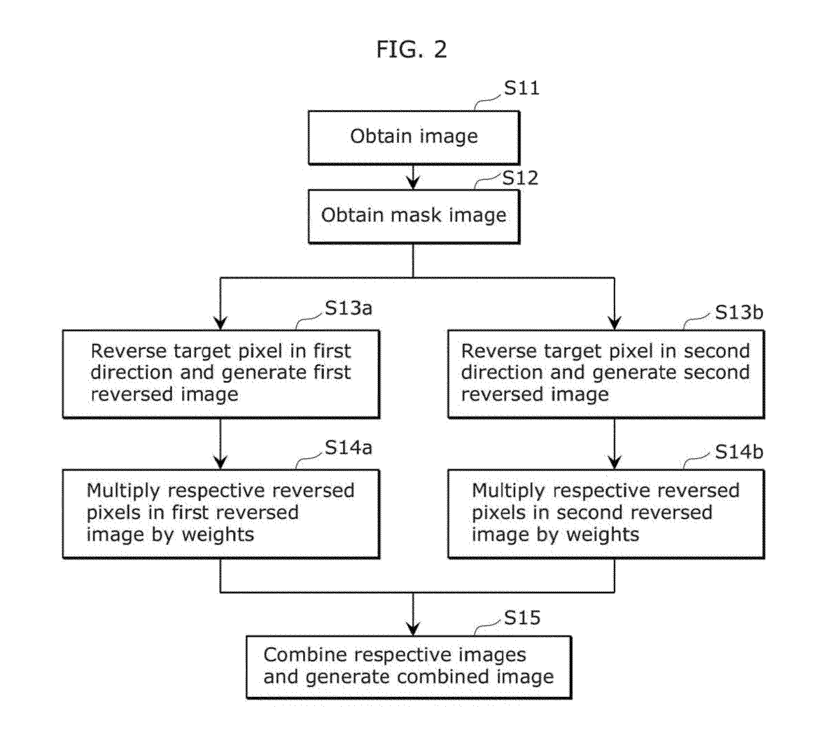

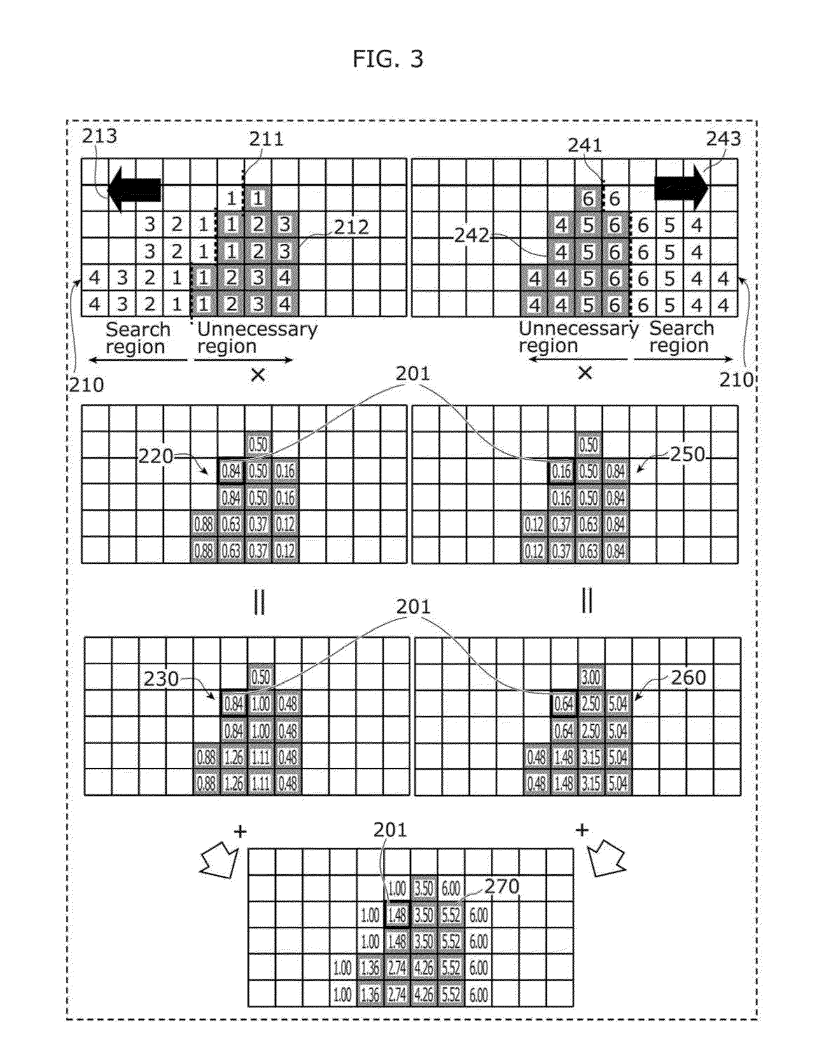

Next, description is provided on a flow showing how to generate a combined image in the image processing apparatus according to the present embodiment, with reference to FIG. 2 and FIG. 3.

First, the image obtaining unit 101 obtains an input age in S11.

Next, the mask image obtaining unit 102 obtains a mask image in S12. The mask image is obtained in a manner as described above.

Next, the first image generation unit 103 generates a first reversed image in a first direction in S13a, and the second image generation unit 104 generates a second reversed image in a second direction in S13b. The first direction and the second direction in the present embodiment are set preliminarily, and in the description below, the first direction is defined as the direction toward the left from the boundary of the unnecessary region in the horizontal direction, and the second direction is defined as the direction toward the right from the boundary of the unnecessary region in the horizontal direction. It is to be noted that the first direction and the second direction are not limited to the above. In S13a and S13b, the reverse boundaries, which are for reversing target pixels to be reversed to the respective pixels in the unnecessary region indicated by the mask image, are set based on the first direction and the second direction, and the respective target pixels are reversed at the reverse boundaries set. An expression “pixels are reversed” has been used. Here, the target pixel is represented by a luminance value or RGB value of the pixel. In the processing described below, practically, processing performed on a pixel is performed on the luminance value or RGB value (that is the pixel value) of the pixel.

Next, in S14a and S14b, the image combining unit 105 multiplies the reversed pixel by a weight. In the present invention, the target pixel is reversed to the unnecessary region not from a single direction but from a plurality of directions, and the pixels reversed from the plurality of directions are combined to be the combined image. Therefore(a plurality of pixel values (that is pixel values from a plurality of directions) is temporarily assigned to the respective pixels in the unnecessary region of the mask image. Therefore, weighting is required when determining to what extent the plurality of assigned pixel values should be reflected on the generation of the respective combined pixels for the respective pixels in the unnecessary region. Derails on values for use in the weighting is described later.

Next, in S15, the image combining unit 105 combines the first reversed image and the second reversed image obtained by multiplying the weighs in S14a and S14b, to generate the combined image.

The following describes a specific example of processing performed in S13a, S13b, S14a S14b, and S15, with reference to FIG. 3.

FIG. 3 shows an input image 210, a first reverse boundary 211 in the first direction, a first reversed image 212, a first direction 213, a weight coefficient 220 of the first reversed image, an image 230 obtained by multiplying the first reversed image by the weight coefficient, a second reverse boundary 241 in a second direction, a second reversed image 242, a second direction 243, a weight coefficient 250 of the second reversed image, an image 260 obtained by multiplying the second reversed image by the weight coefficient, and a combined image 270 obtained by combining the first reversed image and the second reversed image. Specific processing is described below.

First, specific processing for generating a reversed image is described (S13a and S13b).

The first image generation unit 103 searches the first reverse boundary 211 that is the boundary at which the respective pixels are reversed, based on the first direction 213 (the left in the horizontal direction), to generate the first reversed image 212. Specifically, the first image generation unit 103 searches the first reverse boundary 211 by identifying the boundary between the unnecessary region and the first search region. Then, the first image generation unit 103: searches the pixels in the input image 210 from the first reverse boundary 211 to a direction toward the left, which is the first direction 213; reverses the pixels at the first reverse boundary 211 to the unnecessary region; and generates the first reversed image 212. Likewise, the second image generation unit 104 searches the second reverse boundary 241 that is the boundary at which the respective pixels are reversed, based on the second direction 243 (the right in the horizontal direction), to generate the second reversed image 242. Specifically, the second image generation unit 104 searches the second reverse boundary 241 by identifying the boundary between the unnecessary region and a second region which is in the first-direction side of the unnecessary region (hereinafter referred to as “second search region”). The second image generation unit 104: searches the pixels in the input image 210 from the second reverse boundary 241 to the right direction, which is the second direction 243; reverses the pixels at the second reverse boundary 241 to the unnecessary region; and generates the second reversed image 242.

Next, processing for multiplying each of the reversed images 212 and 242 by the weight is described (S14a and S14b).

The image combining unit 105 generates the image 230 by: calculating the weight coefficients 220 for the respective pixels in the first reversed image 212 in a manner that the weight increases as the distance from the first reverse boundary 211 is closer; and multiplying the respective pixels in the first reversed image 212 by the calculated weight coefficients 220. Likewise, the image combining unit 105 generates the image 260 by: calculating the weight coefficients 220 for the respective pixels in the second reversed image 242 in a manner that the weight increases as the distance from the second reverse boundary 241 is closer; and multiplying the respective pixels in the second reversed image 242 by the calculated weight coefficients 250.

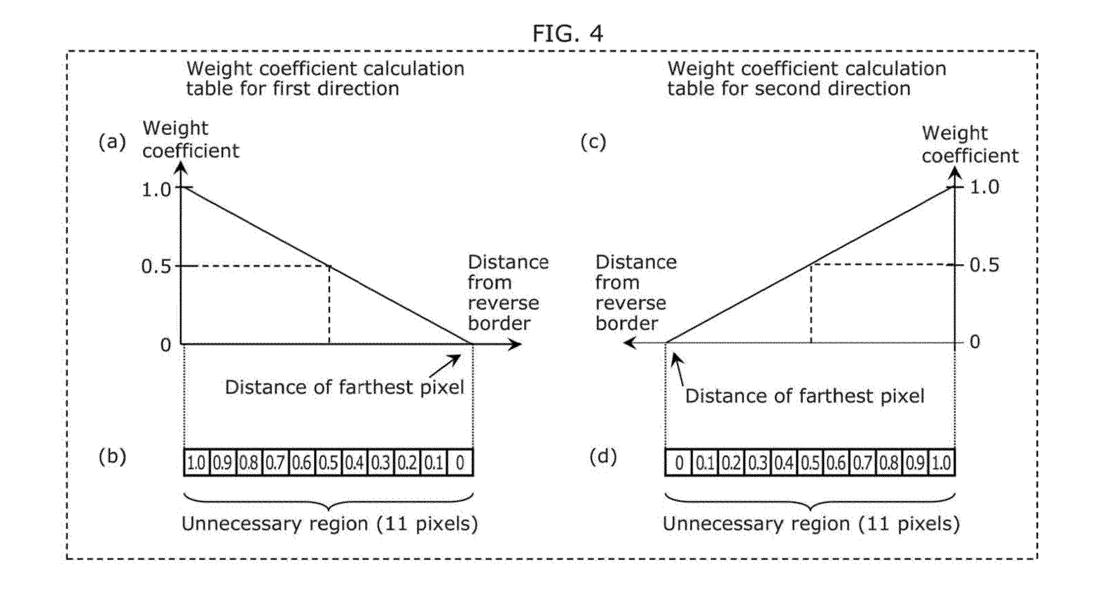

The weight coefficient used here is set according to an arbitrary way. In the example in FIG. 3, a first weight coefficient of a given pixel 201 is set to 0.84 and a second weight coefficient of the same is set to 0.16, which means the sum of the first weight coefficient and the second weight coefficient is equal to 1. It is beneficial to set the weight on condition that the sum of the weights of a plurality of directions becomes 1, as described above, Specifically, the image combining unit 105 may set the first weight coefficient and the second weight coefficient, for each of the pixels included in the unnecessary region, in a manner that the sum of the following becomes 1: the first weight coefficient which has been multiplied by a pixel in the first reversed image at a position corresponding to the pixel; and the second weight coefficient which has been multiplied by a pixel in the second reversed image at a position corresponding to the pixel. Furthermore, as an example, a table shown in FIG. 4 may be used for calculating the weight, when setting the respective weight coefficients in a manner that the weight increases as the distance from the reverse boundary is closer, (a) in FIG. 4 shows a table for weight coefficient calculation in the first direction. In the table, the weight coefficient of the pixel positioned the closest out of the unnecessary region is set to 1.0, and the weight coefficient of the pixel positioned the farthest out of the unnecessary region is set to 0, according to the distance from the reverse border. (b) in FIG. 4 shows pixels in which the weight coefficients resulting from calculation in the first direction are assigned to the respective pixels by referring to the table in (a), in the case where the number of pixels in the unnecessary region is 11. Likewise, (c) in FIG. 4 shows the weight calculation table for the second direction, and (d) in FIG. 4 shows pixels in which the weight coefficients are assigned to the respective pixels in the case where the number of pixels in the unnecessary region is 11. As described above, by setting the weight in a manner that the weight increases as the distance from the reverse boundary is closer and that the sum of the weights from the plurality of directions becomes 1, the pixels from the plurality of directions can be reflected on the reversed image, with improved accuracy. It is to be noted that the second table is not necessary and only the first table may be provided. Specifically, in such a case, the weight in the second direction can be calculated in a manner that the sum of the weight in the second direction and the weight coefficient calculated using the first table becomes 1. Furthermore, the table is not limited to the one expressed by the direct function (straight line) as shown in FIG. 4, and the one expressed by the quadratic function (curved line) may be used. Specifically, the shape of the function for the table is not limited as long as it is the function of monotone decrease, in which the weight coefficient of the pixel closest to the reverse boundary is set to 1.0 and the weight coefficient of the pixel farthest out of the unnecessary region is set to 0.

Then, the weights calculated according to the above manner are multiplied with the respective pixel values in the reversed image. In FIG. 3, regarding the pixel 201, a value of 1×0.84=0.84 is assigned to the first direction, and a value of 4×0.16=0.64 is assigned to the second direction.

Finally, processing for combining the plurality of images multiplied by the weights are described (S15).

As shown in the example in FIG. 3, the image 230 and the image 260 are combined to generate the combined image 270 in which the unnecessary region has been complemented. It can be understood that, for the given pixel 201, a resultant value of 1.48 is obtained by summing (i) the calculated value of 0.84 from the first image and (ii) the calculated value of 0.64 from the second image.

It is to be noted that the respective weight coefficients assigned to the following are set to 0.5: the pixels in the region excluding the unnecessary region in which the first reversed image is generated; and the pixels in the region excluding the unnecessary region in which the second reversed image is generated.

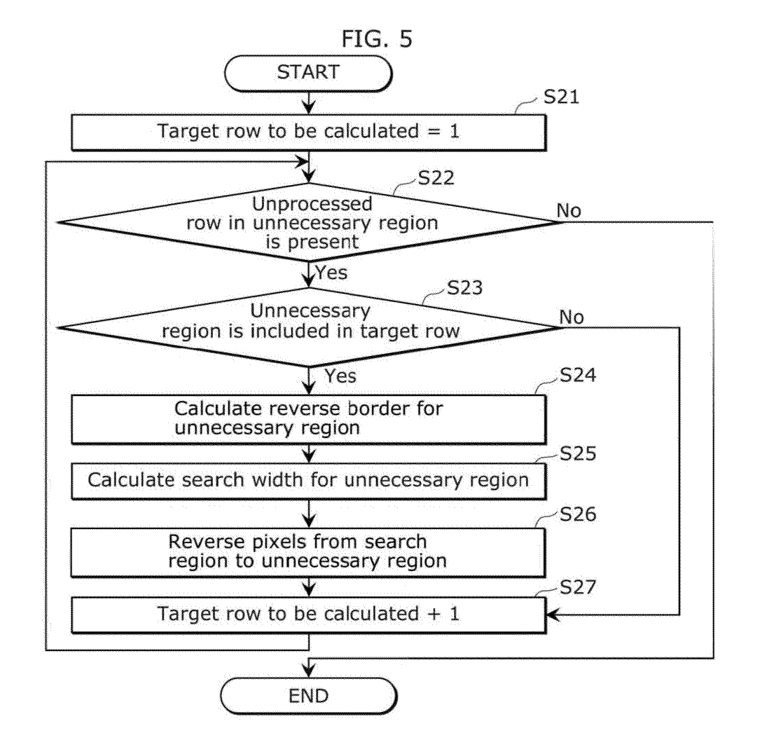

Next, the order of the reversed image generation processing performed by the image generation unit 110 in S13a and S13b are described in further details, with reference to FIG. 5. In FIG. 5, since the first direction and the second direction are in the horizontal direction in Embodiment 1, the reversed image generation processing can be divided into processing per row.

First, when the processing is started, in S21, the image generation unit 110 sets the target row to be calculated in the input image as the first row, and proceeds to S22.

In S22, the image generation unit 110 determines whether or not an unprocessed row including the unnecessary region is present, and proceeds to S23 when the unprocessed row is present (S22: Yes), while ending the reversed image generation processing when the unprocessed row is not present (S22: No) since the generation processing has been completed.

In S23, the image generation unit 110 determines whether or not the unnecessary region is included in the target row, and proceeds to S27 when the unnecessary region is not included (S23: No), while proceeding to S24 when the unnecessary region is included (S23: Yes).

In S24, the image generation unit 110 identifies the reverse boundary in the unnecessary region corresponding to the reverse direction (that is the first direction or the second direction), and proceeds to S25.

In S25, the image generation unit 110 calculates a search width of the unnecessary region which is used as the basis for determining a width for which the reversing is performed from the reverse boundary identified in S24 (that is a width of the unnecessary region in the row), and proceeds to S26. It is to be noted that the “search width of the unnecessary region” here is a first search width in the case of first reversed image generation processing, while being a second search width in the case of second reversed image generation processing.

In S26, the image generation unit 110 searches the pixels in the designated reverse direction for the search width of the unnecessary region from the reverse boundary, generates the reversed image for one row by reversing, at the reverse boundary, the pixels for the search width that have been searched, and proceeds to S27.

In S27, the image generation unit 110 increments the target row by 1, and the processing proceeds to S22. Specifically, in S27, processing is performed on the next row of the row which has been targeted until S26. It is to be noted that when the next row is not present, the generation processing may be ended.

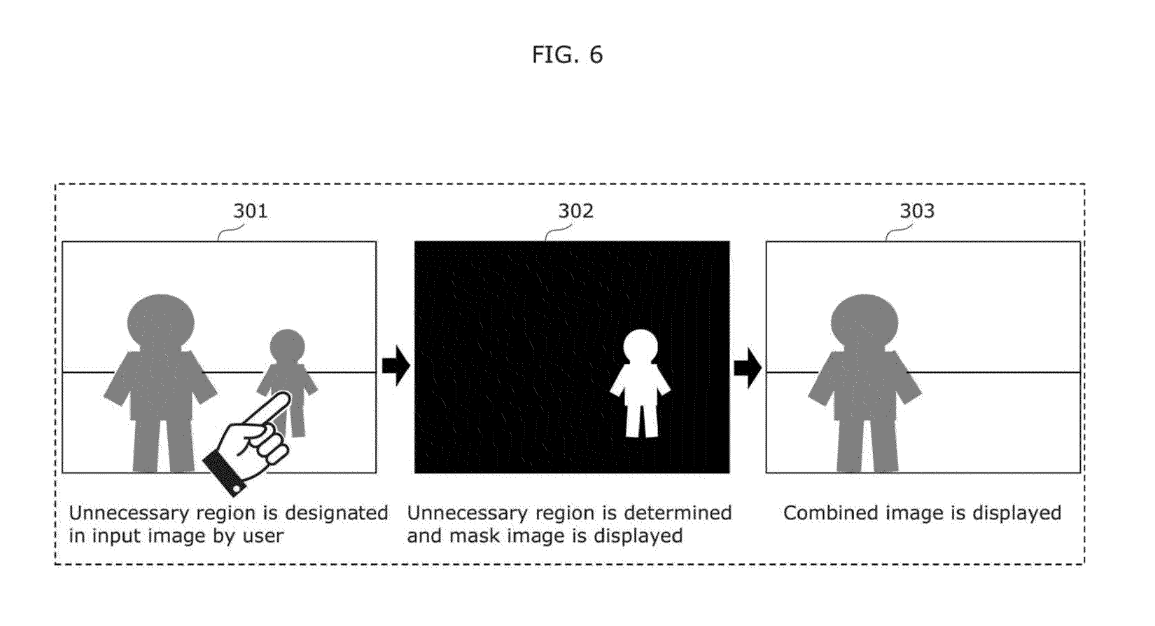

FIG. 6 shows an example of the UI display in the case where the image processing apparatus 100 according to the present invention has been adopted for an imaging apparatuses or a mobile terminal with an image display unit 106. First, an unnecessary region is designated by the user through an operation, such as touching or tracing, performed on an input image 301. Then, a mask image 302 is generated and the determined unnecessary region is displayed. When an input indicating a determination etc, is performed or after a given time period has passed, a combined image 303 is displayed. At this time, the mask image 302 does not have to be the one shown in FIG. 6. It is sufficient when the unnecessary region is displayed on the original image in a visually easily understandable manner. Specifically, the contour of unnecessary region may be enclosed with a frame, or all of the plurality of pixels included in the unnecessary region may be filled with the same pixels (black pixels for example) indicating the unnecessary region. Furthermore, it is not necessary to display the mask region as in the mask image 302, and the combined image may be displayed immediately after the unnecessary region has been designated by the user. Furthermore, FIG. 6 is a mere example, and another UI display may be adopted in which an order of operation for removing the unnecessary region is presented to the user.

As described above, in the image processing apparatus 100 according to the present embodiment, generation of the combined images with improved accuracy is realized by: generating images by reversing the pixels along with the reverse boundaries of the unnecessary region from each of the first direction that is the left direction and the second direction that is the right direction, in the horizontal direction; and combining the generated images. The image processing apparatus 100 is capable of performing natural complement processing which can support various scenes, by generating a plurality of reversed images for use in complementing the unnecessary region from a plurality of directions, which is different from complementing from a single direction only. Furthermore, when generating the combined image, the pixel in the first direction and the pixel in the second direction are multiplied by the respective weight coefficients before combining the pixels. Therefore, blurs seen in the combined image resulting from the combination in the conventional technique can be suppressed, and a more natural unnecessary region complement processing can be realized.

Although in the present embodiment the first direction and the second direction are defined as the left direction and the right direction in the horizontal direction, respectively, the direction may be another direction. Specifically, the first direction may be an upper direction in the vertical direction, and the second direction may be a lower direction in the vertical direction. Furthermore, the first direction and the second direction do not have to be aligned on the same straight line. In this case, the image processing apparatus according to the present embodiment may further include a direction determination unit. Furthermore, after S12 in the processing flow, a step may be newly added in which the direction determination unit determines the direction and the boundary for performing reversing according to the determined direction.

Furthermore, in Embodiment 1, it is assumed that the picture is taken along the horizontal line and the buildings etc. captured by the camera are placed substantially vertically on the horizontal line, as in general photo taking. Although the first direction and the second direction are assigned to the horizontal direction for this reason, the first direction and the second direction may be assigned by detecting the tilt of the camera using a digital compass etc for example.

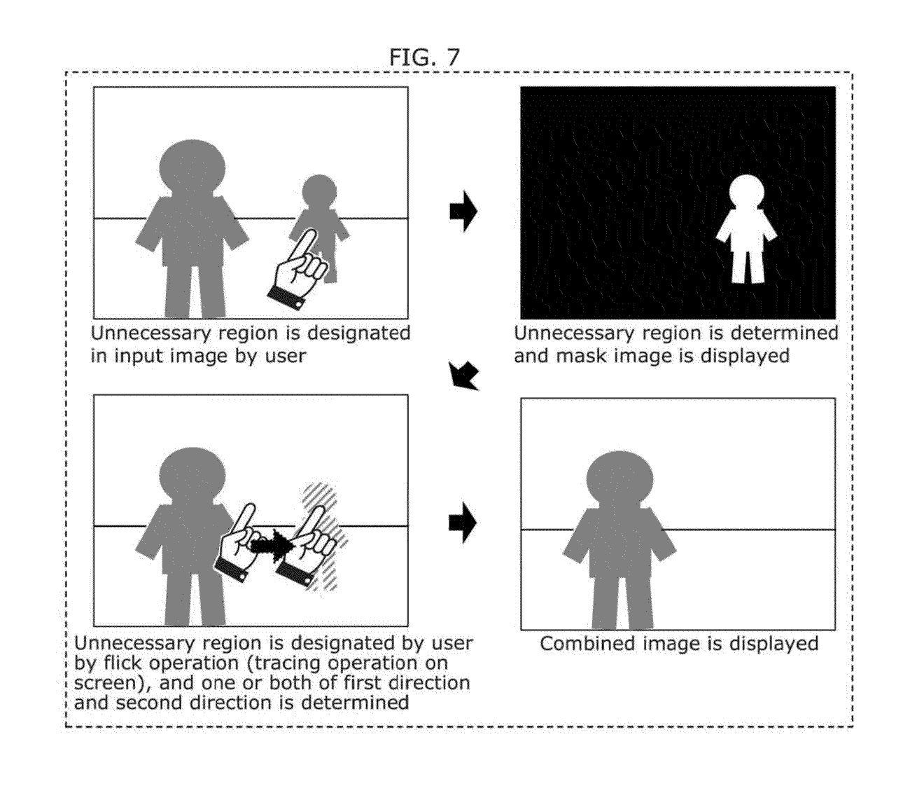

Furthermore, the reverse direction may be assigned through the user's designation of the unnecessary region by a movement to trace the unnecessary region on the touch panel followed by a flick operation to move a finger quickly, in a desired direction determined by the user after confirming the image. For example, the direction designated by the flick operation may be determined as the first direction and the direction opposite the first direction by 180 degrees may be determined as the second direction. With this, the user can select a desirable way for complementing the unnecessary region. Therefore, the will of the user can be reflected on the complement result. Since the combined image on which the user's will is reflected more can be generated as described above, this image processing apparatus may be realized as an image processing apparatus which generates the reversed image only from one direction instead of generating the reversed images from a plurality of directions as in Embodiment 1. Specifically, the image processing apparatus may be implemented as an image processing apparatus including a display unit configured to receive a touch input from a user, the apparatus including: a first detection unit configured to detect a region, which is identified through a first touch input made in an input image displayed on the display unit, as an unnecessary region in the input image; a second detection unit configured to detect a second touch input made after the detection of the unnecessary region by the first detection unit, and when the second touch input indicates a movement having a distance greater than or equal to a predetermined value, detect a direction of the movement as the first direction; an image generation unit configured to generate a first reversed image by performing, on a first region adjacent in the first direction to the unnecessary region, first processing for reversing at a boundary of the unnecessary region to place, in reverse order, a first pixel group in a direction opposite the first direction, the first processing being repeated in a direction orthogonal to the first direction, the first pixel group consisting of pixels continuously arranged in the first direction, for a first width in the first direction in the unnecessary region; an image combining unit configured to generate a combined image by combining the input image and the first reversed image; and the display unit configured to display the combined image. Furthermore, in this case, a third detection unit may be further included which detects a region identified through a touch input in an input image displayed on the display unit, as a prohibited region in the input image, at a time different from that in the detection by the first detection unit and the second detection unit, and the image generation unit may generate the first reversed image by generating the first reversed image by performing, on a region excluding the prohibited region out of the first region, the first processing repeatedly in the direction orthogonal to the first direction, when the prohibited region is in the first direction from the unnecessary region. Furthermore, a fourth detection unit may be further included which detects a region identified through a touch input in the input image displayed on the display unit, as a search region in the input image, at a time different from that in the detection by the first detection unit and the second detection unit, and the image generation unit may generate the first reversed image by generating the second reversed image by performing, on a region excluding the prohibited region out of the second region, the second processing repeatedly in the direction orthogonal to the second direction, when the prohibited region is in the second direction from the unnecessary region. FIG. 7 shows the UI display for the operation performed in the above case.

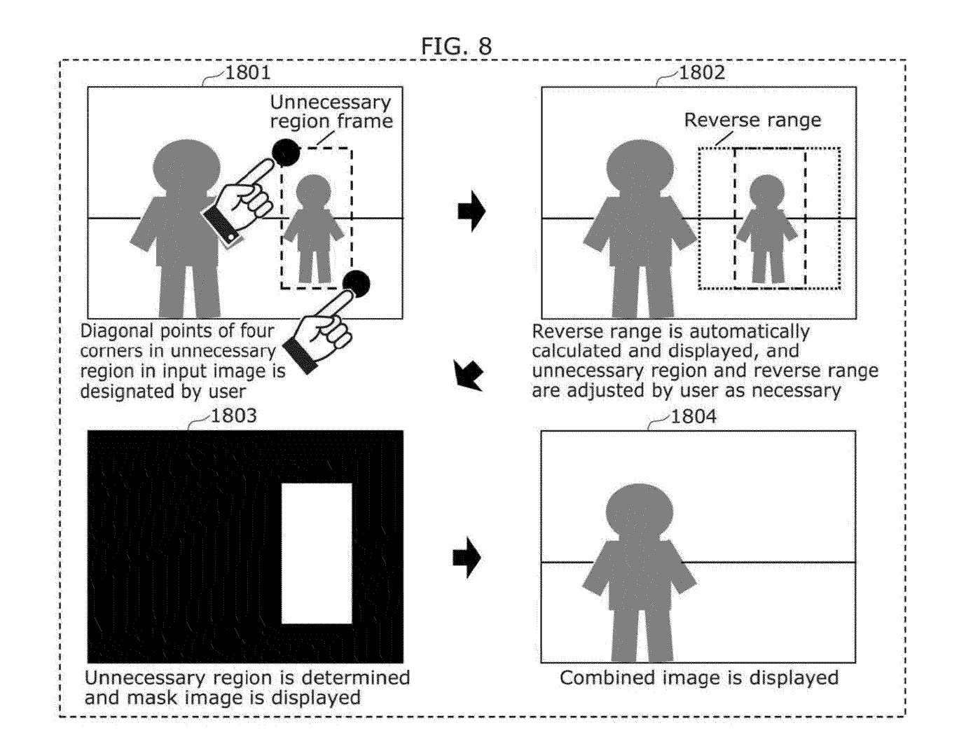

Furthermore, the user may designate, on the touch panel, a search region for searching the reversed image, after designating the unnecessary region. For example, (i) a first rectangle for designating an unnecessary region and (ii) a second rectangle for showing a search region for use in generating a reversed image may be displayed on the input screen, for allowing the user to instruct the first rectangle indicating the unnecessary region and the second rectangle indicating the search region by adjusting the four corners of the respective rectangles. FIG. 8 shows the UI display for the operation performed in the above case.

This allows the user to designate the desired unnecessary region and the desired search region for complementing the unnecessary region. Even in this case, the image processing apparatus 100 may determine the first direction and the second direction for reversing the pixels based on the direction designated by the user through flick operation.

Likewise, a region in a circumscribing rectangle having two points designated by the user on the touch panel as the opposing corners may be determined as an unnecessary region or the search region, and the unnecessary region or the search region may be determined by the user's adjusting the size or the position of the center of gravity through pinch operation and so on.

Although in Embodiment 1 the reversed image is generated by performing processing for reversing one time and placing the pixels, which are obtained by searching for the search width of the unnecessary region from the reverse boundary, this is not the only example. For example, in the case where the search width of the unnecessary region is wide, the search region for generating the reversed image is widened which may cause an unnatural reversing result because of inclusion of a foreground image including person etc. in the reversing, though the background image around the unnecessary region is supposed to be reversed for complementing. In view of this, a threshold may be set for the search width, to perform the reversing for two or three times when the search width is greater than or equal to the threshold. Furthermore, the threshold may be a fixed value which is preliminarily set, the width of the first search region, or the width of the second search region. In the latter case, the first search width is compared with the width of the first search region in the first direction, and the second search width is compared with the width of the second search region in the second direction. Then, the image generation unit may, when it is determined that the number of the pixels continuously arranged in the first direction in the first search region is smaller than the number of the pixels for the first search width, obtain a pixel group consisting of pixels continuously arranged in the first direction in the first region, and generate the first reversed image by performing processing for repeatedly reversing and placing the pixel group in a direction opposite the first direction until the first width is satisfied, as the first processing, the first processing being repeated in a direction orthogonal to the first direction. Furthermore, the image generation unit may, when it is determined that the number of the pixels continuously arranged in the second direction in the second search region is smaller than the number of the pixels for the second width, obtain a pixel group consisting of pixels continuously arranged in the second direction in the second region, and generate the second reversed image by performing processing for repeatedly reversing and placing the pixel group in a direction opposite the second direction until the second width is satisfied, as the second processing, the second processing being repeated in a direction orthogonal to the second direction. The “processing for repeatedly reversing and placing the pixel group” here indicates, for the case of a pixel group consisting of pixels continuously arranged in the first direction for example, processing for reversing and placing the pixel group in a direction opposite the first direction at the first reverse boundary, and then reversing and placing the pixel group again in the opposite direction at a pixel at an edge, in the opposite direction, of the pixel group which is already reversed and placed. Specifically, when the width of the obtained pixel group in the first direction is smaller than the first search width, the first reversed image for the first search width can be generated by performing the “processing for repeatedly reversing and placing the pixel group” for a plurality of times until the first search width is satisfied. Furthermore, the “processing for repeatedly reversing and placing the pixel group” is also performed in the second direction, as described above.

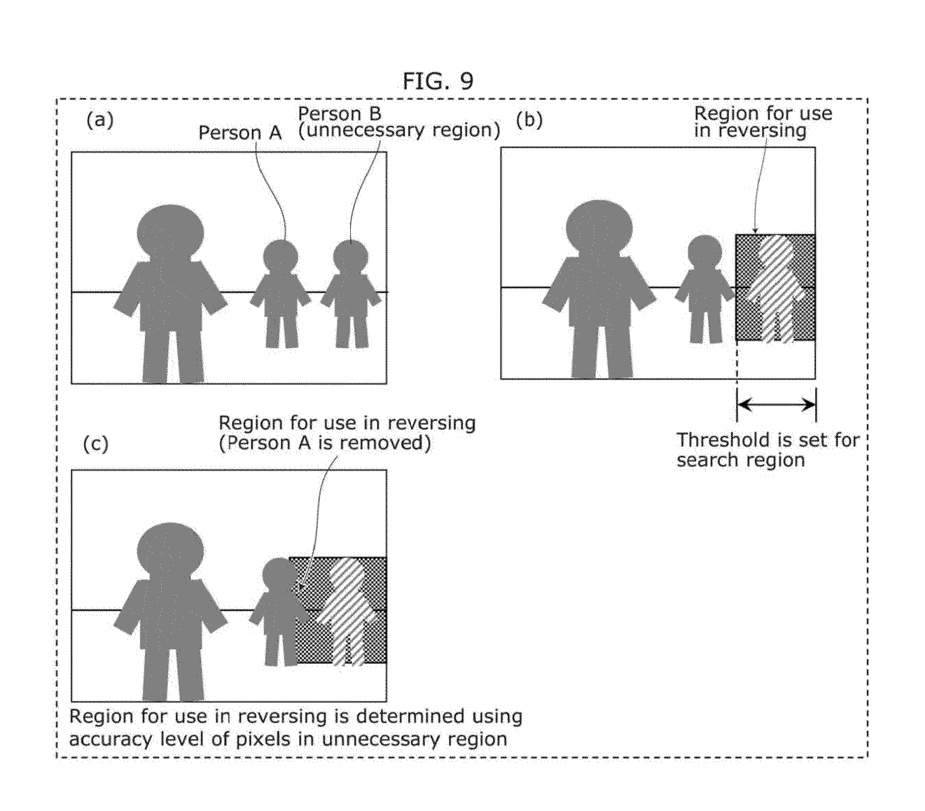

Furthermore, when the threshold is set for the search width, the amounts of change in color, luminance difference, and the edge strength from the reverse boundary may be taken into consideration. With this, accuracy level of the background image around the unnecessary region can be evaluated based on the distance from the reverse boundary, color, luminance difference, and edge strength, to exclude the foreground image, which is the cause of unnatural reversing, from the target pixels to be reversed. For example, as shown in (a) in FIG. 9, in the case where Person A that is the region other than the background is present close to Person B that is the unnecessary region, when the reversed image is generated without taking Person A into consideration, part of the pixels included in Person A is directly included into part of the target pixels. Therefore, the intended combined image cannot be obtained. In view of this, a threshold (that is a region for a predetermined width) may be set for the search region as shown in (b) in FIG. 9, to determine the region within the threshold as the search region and reverse the pixels in the search region for a plurality of times (for example, two or three times). Specifically, the pixels in the search region that is the region within the threshold may be obtained and processing for repeatedly reversing and placing the obtained pixels may be performed, Furthermore, as shown in (c) in FIG. 9, a region for use in reversing may be set based on the accuracy level of the pixels around the unnecessary region.

Specifically, the image processing apparatus may further include a region setting unit which sets a prohibited region. In this case, the image generation unit generates the first reversed image by obtaining a first pixel group from a region excluding the prohibited region out of the first region, when the prohibited region is in the first direction from the unnecessary region. Furthermore, the image generation unit generates the second reversed image by obtaining a second pixel group from a region excluding the prohibited region out of the second region, when the prohibited region is in the second direction from the unnecessary region. It is to be noted that the region setting unit may set the prohibited region based on an input by the user, or based on the result of image processing or image recognition using the accuracy level of the background image, for example. Specifically, the prohibited region may be set according to the above-described scheme for detecting the unnecessary region through image processing or image recognition.

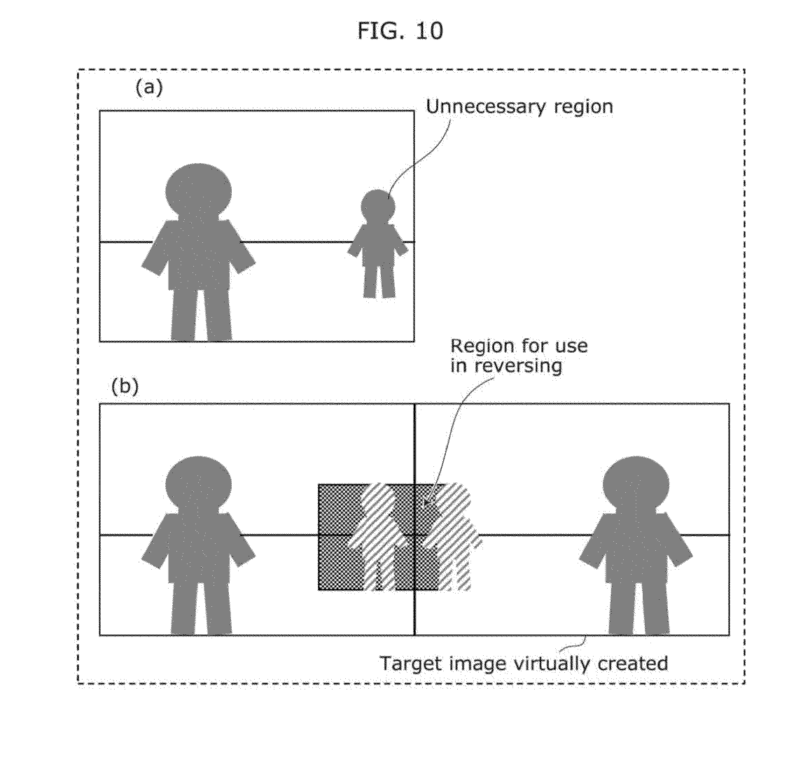

Furthermore, when the unnecessary region is present near the edge of the image as shown in (a) in FIG. 10, the unnecessary region may be complemented from only the first direction. Furthermore, as shown in (b) in FIG. 10, a symmetrical image may be virtually generated to virtually generate a search region for use in reversing. Specifically, the reversed image may be generated by virtually placing an image obtained by inverting the input image in the second direction (right direction) of the input image and expanding the search region for used in reversing.

Although the two processing units namely the first image generation unit and the second image generation unit are used in the present embodiment, this is not the only example. For example, (i) a third image generation unit which generates a third reversed image by reversing the pixels in a third direction that is an upper direction of the boundary of the unnecessary region and (ii) a fourth image generation unit which generates a fourth reversed image by reversing the pixels in a fourth direction that is a lower direction of the boundary of the unnecessary region may be included, and the image combining unit may combine the first reversed image, the second reversed image, the third reversed image, and the fourth reversed image.

Furthermore, both directions on a rising diagonal line from bottom left to top right by 45 degrees may be set as a fifth direction and a sixth direction, and a fifth image generation unit which generates images from the boundary of the unnecessary region in the top right direction (fifth direction) and a sixth image generation unit which generates images from the boundary of the unnecessary region in the bottom left direction (sixth direction) may be included. In addition, both directions on a falling diagonal line from top left to bottom right by 45 degrees may be set as a seventh direction and a eighth direction, and a seventh image generation unit which generates images from the boundary of the unnecessary region in the top left direction (seventh direction) and a eighth image generation unit which generates images from the boundary of the unnecessary region in the bottom right direction (eighth direction) may be included. In this case, the image combining unit may combine the first to eighth reversed images. Furthermore, an image generation unit may be included which sets n directions at which the reversing is started, and the reversed images generated by the image generation unit may be used for generating the combined image.

Furthermore, when calculating the weight according to the distance from the reverse boundary for use in combining the combined image, the weight may be assigned equally to each of the first to the nth reversed images, and, on the contrary, may be assigned unequally. For example, when generating the first reversed image, in the case where distribution of the luminance, color, edge strength, and edge direction, in the search region that is used as the reference for reversing is largely different from those in the search region used for generating the remaining second to n-th reversed images, the image combining unit may set the weighting coefficient of the first reversed image to be smaller than the weight coefficients of the second to n-th reversed images.

The above is based on an assumption that the complement is performed using the background image around the unnecessary region. However, depending on the directions, there are cases where a great portion of the search region is occupied by a foreground image different from the background instead of the assumed background image. In these cases, the obtained result is different from the tendency in other search regions. Therefore, it is intended to minimize complement of the unnecessary region using unintended images, by calculating the tendencies in the search regions in the respective directions and increasing the ratio of image combination using the reversed image obtained by complementing using the search regions having similar tendencies.

Furthermore, when the user designates the unnecessary region on the touch panel or the candidate for the unnecessary region is automatically detected through image processing, there are cases where a part of the target region to be deleted is not designated as the unnecessary region and therefore the part of the target region is present outside of the boundary of the region designated as the unnecessary region. In these cases, when the reversed image is generated, the part of the target region is included into the reversed image, causing a problem that the target region is emphasized with being twice the size in the generated combined image.

In view of this, for example, after the mask image is obtained, image expansion processing is performed to expand the boundary of the unnecessary region by an arbitrary number of pixels. Specifically, a region, which is larger than the region designated as the unnecessary region by the expanded range, is identified as the unnecessary region. With this, even when part of the region intended to be deleted is not included in the designated region, the part can be deleted. Furthermore, as another measure, it is possible to perform image processing on the mask image and the input image, to expand the mask image to allow the boundary (edge) of the unnecessary region of the mask image to match the edge of the input image.

Furthermore, in the above description, the first reversed image and the second reversed image are generated using the image in the same size as the input image. Specifically, the first reversed image and the second reversed image are images generated for complementing the unnecessary region with maintaining the pixel values of the pixels in the region excluding the unnecessary region of the input image. However, without being limited to the above, the first reversed image and the second reversed image may be generated using the image in the same size as the unnecessary region. Specifically, these images may be generated as the images for replacing the unnecessary region. In this case, the image combining unit generates a complement image for replacing the unnecessary region by combining the first reversed image and the second reversed image. Then, the image combining unit combines the combined image by replacing the unnecessary region of the input image with the complement image.

### Embodiment 2

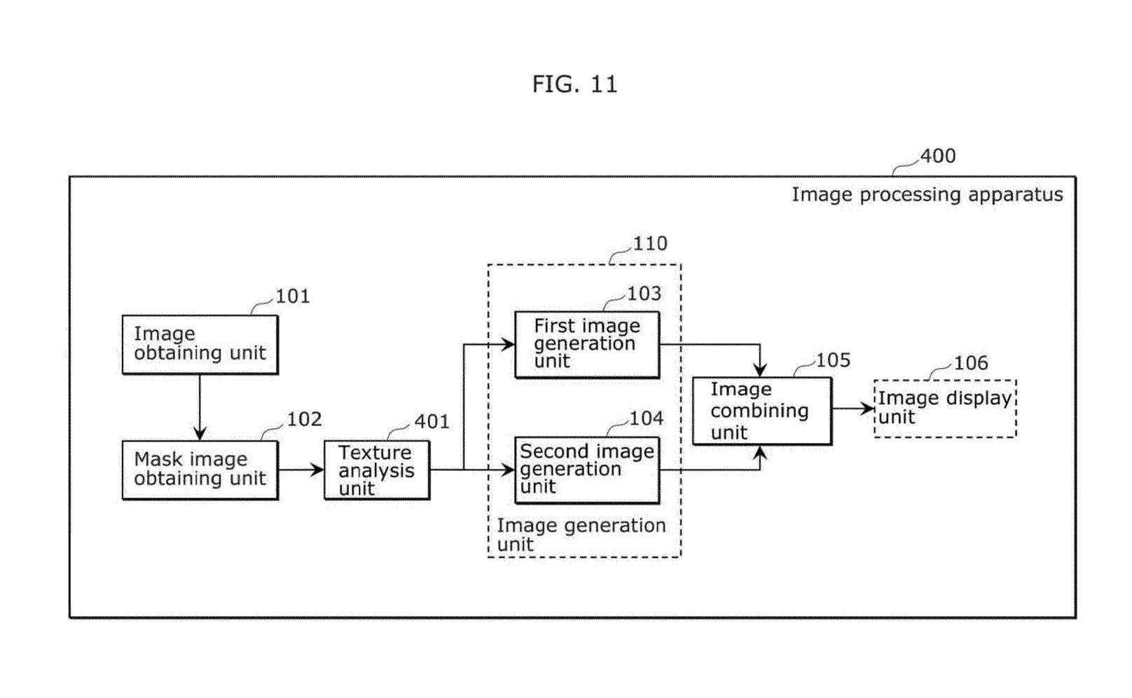

FIG. 11 shows a configuration of an image processing apparatus according to Embodiment 2 of the present invention. In FIG. 11, constituent elements common to FIG. 1 are denoted by the same numerals and description is omitted.

In FIG. 11, an image processing apparatus 400 according to the present embodiment includes the image obtaining unit 101, the mask image obtaining unit 102, a texture analysis unit 401, the image generation unit 110, and the image combining unit 105. The image generation unit 110 includes the first image generation unit 103 and the second image generation unit 104. Furthermore, the image processing apparatus 400 according to Embodiment 2 of the present invention may include the image display unit 106 as shown in FIG. 11.

The image processing apparatus 400 according to Embodiment 2 has a feature of including the texture analysis unit 401 which determines the first direction and the second direction by analyzing the texture in the peripheral region of the unnecessary region.

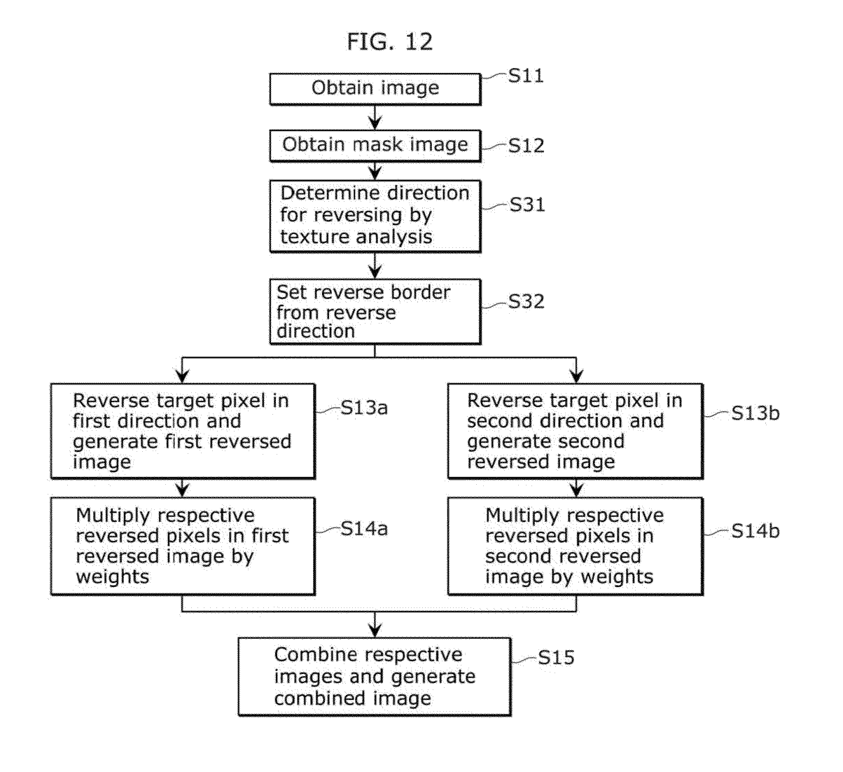

FIG. 12 shows a flow for generating a combined image performed by the image processing apparatus 400 according to the present embodiment. Description on S11, S12, S13a, S13b, S14a, S14b, and S15 is omitted since these are the same as those performed by the image processing apparatus according to Embodiment 1 when generating the combined image.

In S31, the texture analysis unit 401 determines the first direction and the second direction.

FIG. 1 shows an example of the boundary peripheral region of an unnecessary region 501 for use in determining the first direction and the second direction by the texture analysis unit. Specifically, the texture analysis unit 401 determines the first direction and the second direction by analyzing the texture in the peripheral region of the unnecessary region.

First, the texture analysis unit 401: calculates a circumscribing circle 502 circumscribing the unnecessary region 501; calculates, as a peripheral region circle 503, a circle that has the radius three times as great as that of the circumscribing circle 502; and determines the peripheral region circle 503 as a target range for texture analysis,

Then, the texture analysis unit 401 generates, in the peripheral region circle 503 that is the target range for texture analysis, an edge image which is a first derivation of the obtained input image using Sobel filtering and so on. The texture analysis unit 401 accumulates, with weighting using the edge strength, a direction of an edge obtained from the edge image to a histogram showing the frequency of the edge direction divided into some stages, and determines an angle orthogonal to a high-frequency angle as the first direction and the second direction. Specifically, the texture analysis unit 401 detects a high-frequency angle from the edge angle per pixel or region which is obtained from the edge image of the input image, and determines the first direction and the second direction as the direction vertical to the detected high-frequency angle. For example, when the peripheral boundary region has ideal horizontal stripes, the edge direction includes a lot of vertical directions, and therefore the high-frequency angle obtained from the edge image corresponds to the vertical direction. In this case, setting the lateral direction orthogonal to the longitudinal direction as the reverse direction allows complementing the unnecessary region with horizontal stripes beautifully.

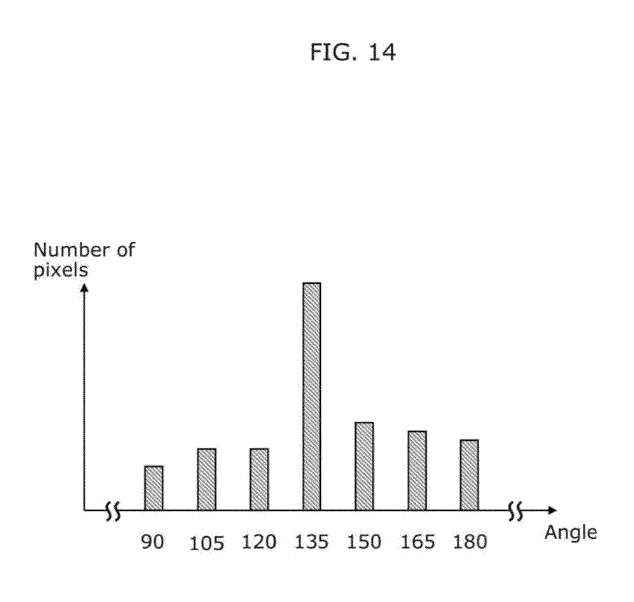

FIG. 14 shows an example of the histogram shoving the frequency of the edge direction. In the case of FIG. 14, the highest-frequency angle is 135 degrees. Therefore, the first direction and the second direction are determined as the directions of 225 degrees and 45 degrees which are orthogonal to the angles, respectively.

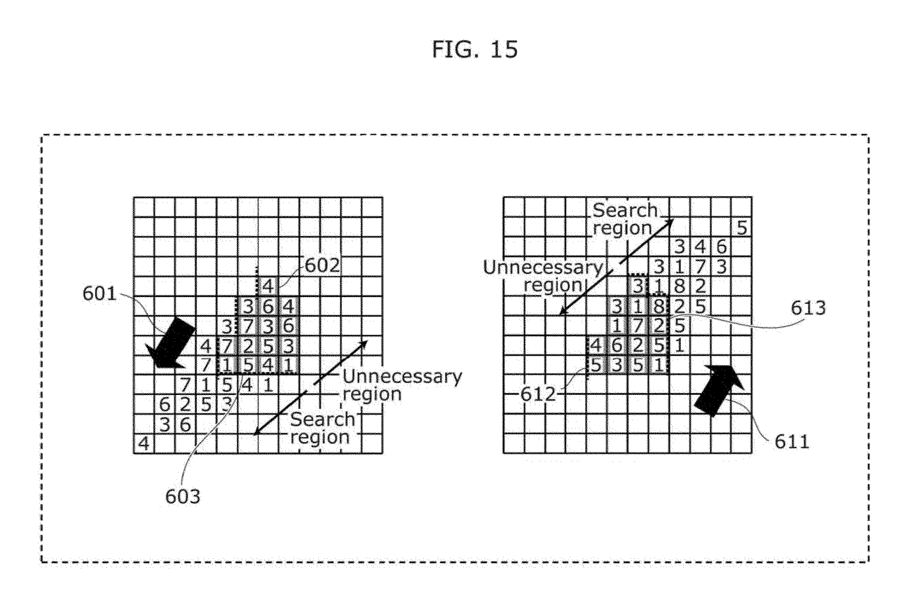

Next, in S32, the texture analysis unit 401 determines the reverse boundaries using the first direction and the second direction which are the determined reverse directions, FIG. 15 shows an example of generation of the reversed image performed by the first image generation unit 103 and the second image generation unit 104. In the example in FIG. 15, the first direction 601 and the second direction 611 are defined as 225 degrees and 45 degrees, respectively, the first reverse boundary 603 and the second reverse boundary 604 are set, and the respective corresponding pixels are reversed. As a result, the first reversed image 602 and the second reversed image 612 are generated as illustrated.

After the above, processing same as in Embodiment 1 is performed to generate the combined image.

With the above processing, the image processing apparatus 400 according to Embodiment 2 can generate the reversed image corresponding to the texture of the peripheral region of the unnecessary region at a higher level. In many cases, the image taken by the user is not completely horizontal but is tilted, Therefore, the horizontal components in the background region are also often displayed with tilted. With the image processing apparatus according to the present embodiment, an angle of the tilt is detected and reflected on the reverse direction, thereby generating further natural combined images.

It is to be noted that the texture analysis unit 401 may detect the highest-frequency line from the edge strength and the edge angle obtained from the edge image of the input image, and define the first direction and the second direction as the both directions on the detected line.

It is to be noted that the texture analysis unit 401 may set the highest-frequency angle as the first direction and set the direction opposite the first direction by 180 degrees as the second direction.

Furthermore, the texture analysis unit 401 may set the angle orthogonal to the second-highest-frequency angle as the third direction, set the direction opposite the third direction by 180 degrees as the fourth direction, and may combine the combined image using the reversed images in the respective directions.

Furthermore, the first direction and the second direction may be assigned not only as a direction opposite each other by 180 degrees, but may be assigned as the first direction, the second direction, the third direction, and so on, in ascending order starting from the highest-frequency angle. Here, the weight coefficient for use in the image combination may be adjusted according not only to the distance from the reverse boundary but also to the frequency of the angle.

With this, the reversed image generation and the image combination can be performed with taking into consideration the texture information in the peripheral boundary region from the plurality of directions, thereby realizing a further natural unnecessary region complement.

Furthermore, the texture analysis unit may detect the tilt of the line in the entire screen or around the unnecessary region through image processing such as Hough transform, and set the detected tilt of the line as the first direction and the second direction.

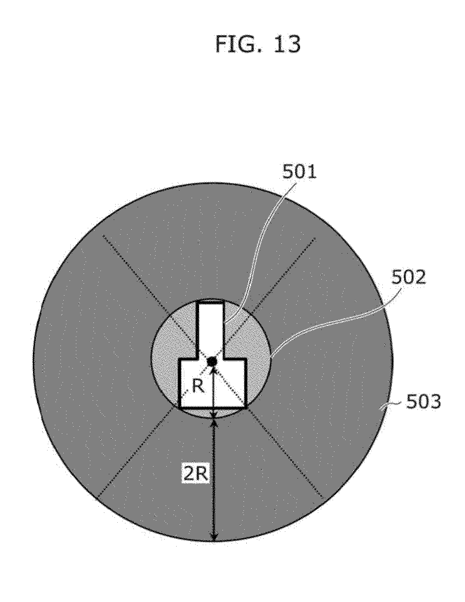

Although the texture analysis unit 401 has calculated the frequency of the edge direction taking the peripheral boundary region as one region, the region may be divided into a plurality of regions and the edge direction frequency may be calculated for the respective regions. For example, the texture analysis unit in this case divides the peripheral region circle 503 in FIG. 13 into four regions by 90 degrees, and determines the highest-frequency directions of the edge directions in the respective divided peripheral region circles as the first direction, second direction, third direction, and fourth direction. Then, four reversed images may be generated in the first to the fourth directions determined by the texture analysis unit, and the image combination may be performed by equally using the four reversed images, to complement the unnecessary region. Furthermore, the image combining unit in this case may determine the weight coefficient using not only the distance from the reverse boundary but also the distance from the center of gravity of the divided boundary peripheral region.

In FIG. 11, the first image generation unit 103 generates the first reversed image by calculating the first reverse boundary based on the first direction, the mask image, and the input image which are obtained from the texture analysis unit 401, Likewise, the second image generation unit 104 generates the second reversed image by calculating the second reverse boundary based on the second direction, the mask image, and the input image obtained from the texture analysis unit 401.

### Embodiment 3

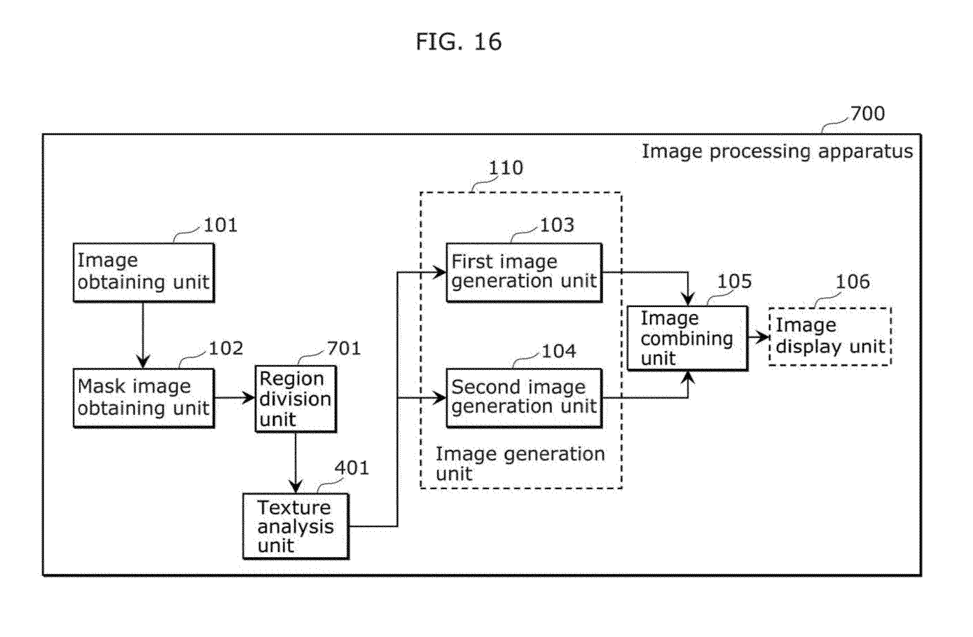

FIG. 16 shows a configuration of an image processing apparatus according to Embodiment 3 of the present invention. In FIG. 16, constituent elements common to FIG. 1 and FIG. 11 are denoted by the same numerals and description is omitted.

In FIG. 16, an image processing apparatus 700 according Embodiment 3 includes the image obtaining unit 101, the mask image obtaining unit 102, the region division unit 701, the image generation unit 110, the image combining unit 105, and the image display unit 106. The image generation unit 110 includes the first image generation unit 103 and the second image generation unit 104. Furthermore, the image processing apparatus 700 according to Embodiment 3 of the present invention may include the image display unit 106 as shown in FIG. 16.

The image processing apparatus 700 according to Embodiment 3 has a feature of further including a region division unit 701 which divides the peripheral region of the unnecessary region out of the input image into a plurality of regions which is a group of pixels having the same or similar features.

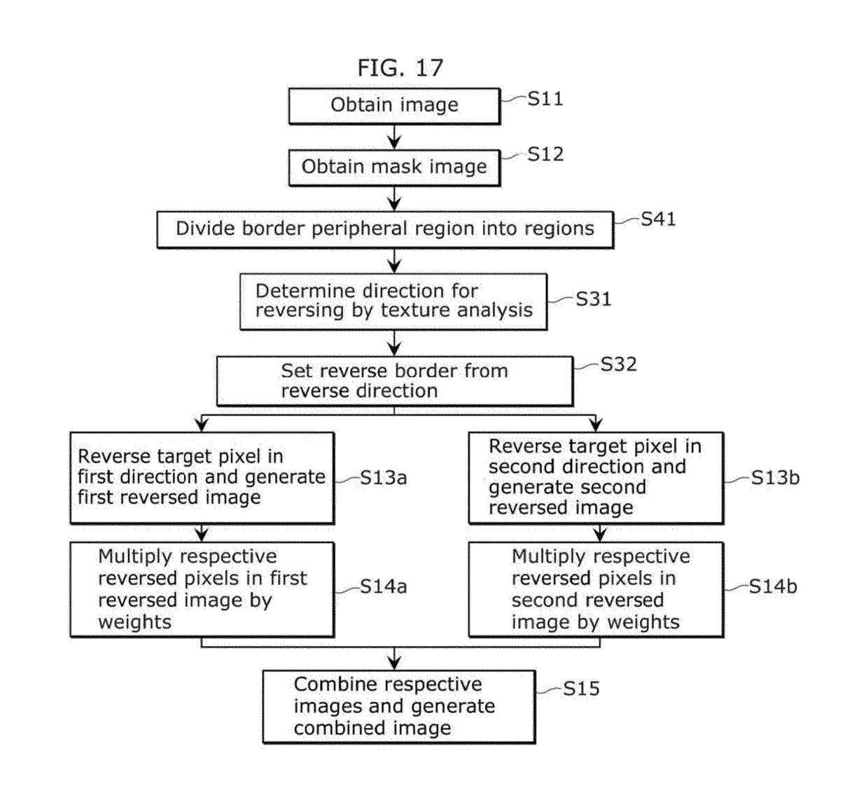

FIG. 17 shows a flow for generating a combined image performed by the image processing apparatus according to the present embodiment. Description on S11, S12, S31, S32, S13a, S13b, S14a, S14b, and S15 is omitted since these are the same as those performed by the image processing apparatuses 100 and 400 according to Embodiment 1 and Embodiment 2 when generating the combined image.

In S41, the region division unit 701 divides h pixels in the boundary peripheral region into regions.

In S31 to S13b, the image generation unit 110 generates a divided reversed image by performing processing for reversing at the boundary of the unnecessary region to place, in reverse order, a pixel group in a direction opposite a predetermined direction, the processing being repeated in a direction orthogonal to the predetermined direction, the pixel group consisting of pixels continuously arranged in the predetermined direction, for a predetermined width set in the region of the unnecessary region.

The region division unit 701 obtains the input image and the mash image from the mask image obtaining unit 102, and divides the boundary peripheral region of the mask image into regions. The region may be divided according to a region division scheme such as cluster sorting used for statistics or the region division scheme used in statistics, the region division scheme used in image processing, such as the mean shift, K-means, and so on.

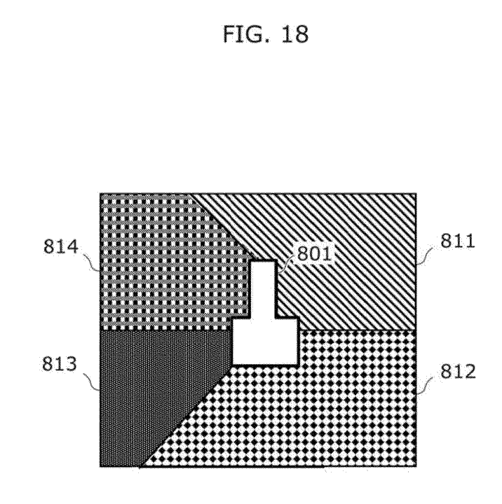

FIG. 18 shows an example of the region division result. Boundary peripheral regions 811 to 814, which have been divided into four regions, are present around the unnecessary region 801. The texture analysis unit 401 calculates the reverse directions for the respective boundary peripheral regions 811 to 814 and the image combining unit 105 combines the four reversed images, thereby realizing complement of the unnecessary region.

The boundary peripheral regions 811 to 814 divided in S41 are transmitted to the texture analysis unit 401, the texture analysis is performed for the respective boundary peripheral regions 811 to 814, and the directions and the reverse boundaries are determined for the respective boundary peripheral regions 811 to 814.

The subsequent processing performed on respective boundary peripheral regions 811 to 814 is the same as those performed in the Embodiment 1 and Embodiment 2.

As described above, with the image processing apparatus according to the present embodiment, further natural combined images can be generated to match the texture of the background, since the division is performed according to the characteristics of the peripheral regions and the reverse directions are determined for the respective regions.

In the image combination, the weight coefficients to be multiplied by the respective reversed images may be determined taking into consideration not only the distances from the reverse boundary but also the distances from the center or center of gravity of the respective divided regions.

### Other Modifications

It is to be noted that although the present invention is described based on aforementioned embodiment, the present invention is obviously not limited to such embodiment. The following cases are also included in the present invention.

(1) The image processing apparatus is, specifically, a computer system including a microprocessor, a ROM, a RAM, a hard disk unit, a display unit, a keyboard, a mouse, and the so on. A computer program is stored in the RAM or hard disk unit, The image processing apparatus performs its functions through the microprocessor's operation according to the computer program. Here, the computer program is configured by combining a plurality of instruction codes indicating instructions for the computer, in order to achieve predetermined functions.

(2) A part or all of the constituent elements included in the image processing apparatus above may include a single System Large Scale Integration (LSI). The System LSI is a super multifunctional LSI manufactured by integrating plural constituent elements on a single chip, and is specifically a computer system including a microprocessor, a ROM, a RAM, and so on, The RAM has a computer program stored. The system LSI achieves its functions through the microprocessor's operation according to the computer program.

(3) A part or all of the constituent elements constituting the image processing apparatus above may be configured as an IC card which can be attached and detached from the image processing apparatus or as a stand-alone module. The IC card or the module may be a computer system including the microprocessor, ROM, RAM, and the like. The IC card or the module may also include the aforementioned super-multi-function LSI. The IC card or the module achieves its function through the microprocessor's operation according to the computer program. The IC card or the module may also be implemented to be tamper-resistant.

(4) The present invention may be a method of the above. The present invention may be a computer program for realizing the previously illustrated method, using a computer, and may also be a digital signal including the computer program.

Furthermore, the present invention may also be realized by storing the computer program or the digital signal in a computer readable recording medium such as flexible disc, a hard disk, a CD-ROM, an MO, a DVD, a DVD-ROM, a DVD-RAM, a BD (Blu-ray Disc: registered trademark), and a semiconductor memory. Furthermore, the present invention also includes the digital signal recorded in these recording media.

Furthermore, the present invention may also be realized by the transmission of the aforementioned computer program or digital signal via a telecommunication line, a wireless or wired communication line, a network represented by the Internet, a data broadcast and so forth.

Furthermore, the present invention may be a computer system including a microprocessor and a memory, and the above memory may store the above computer program and the microprocessor may operate according to the above computer program.

Furthermore, by transferring the program or the digital signal by recording onto the aforementioned recording media, or by transferring the program or digital signal via the aforementioned network and the like, execution using another independent computer system is also made possible.

(5) Each of the above embodiment and modification examples may be combined.

(6) It is to be noted that in each of the above non-limiting embodiments, each constituent element may be implemented by being configured with a dedicated hardware or being executed by a software program appropriate for each constituent element. Each constituent element may be implemented by reading and executing the software program recorded on a hard disk or a recording medium such as a semiconductor memory, performed by a program execution unit such as a CPU or a processor. Here, the software which implements an information terminal device or the like in each of the above non-limiting embodiments is a program described below.

Specifically, the program causes a computer to perform an image processing method, including: obtaining an input image; obtaining region information indicating an unnecessary region in the input image; (i) generating a first reversed image by performing, on a first region adjacent in a first direction to the unnecessary region indicated by the region information, first processing for reversing at a boundary of the unnecessary region to place, in reverse order, a first pixel group in a direction opposite the first direction, the first processing being repeated in a direction orthogonal to the first direction, the first pixel group consisting of pixels continuously arranged in the first direction, for a first width in the first direction in the unnecessary region, and (ii) generating a second reversed image by performing, on a second region adjacent in a second direction to the unnecessary region, second processing for reversing at a boundary of the unnecessary region to place, in reverse order, a second pixel group in a direction opposite the second direction, the second processing being repeated in a direction orthogonal to the second direction, the second pixel group consisting of pixels continuously arranged in the second direction, for a second width in the second direction in the unnecessary region; and generating a combined image by combining the first reversed image and the second reversed image generated in the generating.

The foregoing has described the image processing apparatus according to one or more embodiments of the present invention. However, the present invention is not limited to these embodiments. Other forms in which various modifications apparent to those skilled in the art are applied to the embodiments, or forms structured by combining constituent elements of different embodiments are included within the scope of the present disclosure, unless such changes and modifications depart from the scope of the present disclosure.

### INDUSTRIAL APPLICABILITY

The image processing apparatus according to the present invention is an image processing apparatus capable of performing complement processing on unnecessary regions with a reduced calculation amount and more naturally, and is useful as an unnecessary region removing application capable of removing unnecessary regions in real-time for digital video cameras and digital cameras, for example.

### REFERENCE SIGNS LIST

100, 400, 700 image processing apparatus
101 Image obtaining unit
102 Mask image obtaining unit
103 First image generation unit
104 Second image generation unit
105 Image combining unit
106 Image display unit
110 Image generation unit
201 Pixel
210 Input image
211 First reverse boundary
212 First reversed image
213 First direction
220 Weight coefficient
230 Image obtained by multiplying first reversed image 312 by weight coefficient 320
241 Second reverse boundary
242 Second reversed image
243 Second direction
250 Weight coefficient
260 Image obtained by r multiplying second reversed image 342 by weight coefficient 350
270 Combined image
401 Texture analysis unit
501 Unnecessary region
502 Circumscribing circle
603 Peripheral region circle
601 First direction
602 First reversed image
603 First reverse boundary
604 Second reverse boundary
611 Second direction
612 Second reversed image
701 Region division unit
801 Unnecessary region
811 to 814 Boundary peripheral region

1-18. (canceled)

19. An image processing apparatus comprising:
an image obtaining unit configured to obtain an input image;
an obtaining unit configured to obtain region information indicating an unnecessary region in the input image;
an image generation unit configured to (i) generate a first reversed image by performing, on a first region adjacent in a first direction to the unnecessary region indicated by the region information, first processing for reversing at a boundary of the unnecessary region to place, in reverse order, a first pixel group in a direction opposite the first direction, the first processing being repeated in a direction orthogonal to the first direction, the first pixel group consisting of pixels continuously arranged in the first direction, for a first width in the first direction in the unnecessary region, and (ii) generate a second reversed image by performing, on a second region adjacent in a second direction to the unnecessary region, second processing for reversing at a boundary of the unnecessary region to place, in reverse order, a second pixel group in a direction opposite the second direction, the second processing being repeated in a direction orthogonal to the second direction, the second pixel group consisting of pixels continuously arranged in the second direction, for a second width in the second direction in the unnecessary region; and
an image combining unit configured to generate a combined image by combining the first reversed image and the second reversed image which are generated by the image generation unit.

20. The image processing apparatus according to claim 19,
wherein the image generation unit is configured to:
(i) when it is determined that the number of the pixels continuously arranged in the first direction in the first region is smaller than the number of the pixels for the first width, obtain a pixel group consisting of pixels continuously arranged in the first direction in the first region, and generate the first reversed image by performing processing for repeatedly reversing and placing the pixel group in a direction opposite the first direction until the first width is satisfied, as the first processing, the first processing being repeated in a direction orthogonal to the first direction; and
(ii) when it is determined that the number of the pixels continuously arranged in the first direction in the second region is smaller than the number of the pixels for the second width, obtain a pixel group consisting of pixels continuously arranged in the second direction in the second region; and generate the second reversed image by performing processing for repeatedly reversing and placing the pixel group in a direction opposite the second direction until the second width is satisfied, as the second processing, the second processing being repeated in a direction orthogonal to the second direction.

21. The image processing apparatus according to claim 19, further comprising a region setting unit configured to set a prohibited region,
wherein the image generation unit is configured to (i) generate the first reversed image by performing, on a region excluding the prohibited region out of the first region, the first processing repeatedly in the direction orthogonal to the first direction, when the prohibited region is in the first direction from the unnecessary region, and (ii) generate the second reversed image by performing, on a region excluding the prohibited region out of the second region, the second processing repeatedly in the direction orthogonal to the second direction, when the prohibited region is in the second direction from the unnecessary region.

22. The image processing apparatus according to claim 19, further comprising a region setting unit configured to set a search region,
wherein the image generation unit is configured to (i) generate the first reversed image by performing the first processing on the search region repeatedly in the direction orthogonal to the first direction, and (ii) generate the second reversed image by performing the second processing on a region excluding the search region repeatedly in the direction orthogonal to the second direction.

23. The image processing apparatus according to claim 19,
wherein the first direction is a direction toward the left from the boundary of the unnecessary region in a horizontal direction, and
the second direction is a direction toward the right from the boundary of the unnecessary region in the horizontal direction.

24. The image processing apparatus according to claim 23,
wherein the image generation unit is further configured to:
(i) generate a third reversed image by performing, on a third region adjacent in a third direction, that is an upper direction in a vertical direction, to the unnecessary region, third processing for reversing at a boundary of the unnecessary region to place, in reverse order, a third pixel group in a direction opposite the third direction, the third processing being repeated in a direction orthogonal to the third direction, the third pixel group consisting of pixels continuously arranged in the third direction, for a third width in the third direction in the unnecessary region; and (ii) generate a fourth reversed image by performing, on a fourth region adjacent in a fourth direction, that is a lower direction in a vertical direction, to the unnecessary region, fourth processing for reversing at a boundary of the unnecessary region to place, in reverse order, a fourth pixel group in a direction opposite the fourth direction, the fourth processing being repeated in a direction orthogonal to the fourth direction, the fourth pixel group consisting of pixels continuously arranged in the fourth direction, for a fourth width in the fourth direction in the unnecessary region, and
the image combining unit is configured to generate a combined image by combining the first reversed image, the second reversed image, the third reversed image, and the fourth reversed image generated by the image generation unit.

25. The image processing apparatus according to claim 19,
wherein the image combining unit is configured to perform the combination by: multiplying pixel values of the respective pixels in the first reversed image by first weights set for the pixel values; multiplying pixel values of the respective pixels in the second reversed image by second weights set for the pixel values; and summing the respective pixel values multiplied by the first weights in the first reversed image and the respective pixel values multiplied by the second weights in the second reversed image.

26. The image processing apparatus according to claim 25,
wherein the image combining unit is configured to set each of the first weight and the second weight to increase for a pixel positioned closer to the boundary of the unnecessary region.

27. The image processing apparatus according to claim 25,
wherein the image combining unit is configured to set the first weight and the second weight for the respective pixels included in the unnecessary region in a manner that a sum of (i) the first weight to be multiplied by a pixel value of a pixel at a position corresponding to the pixel in the first reversed image and (ii) the second weight to be multiplied by a pixel value of a pixel at a position corresponding to the pixel in the second reversed image is equal to 1.

28. The image processing apparatus according to claim 19, further comprising
a texture analysis unit configured to analyze texture of a peripheral region of the unnecessary region to determine the first direction and the second direction.

29. The image processing apparatus according to claim 28, wherein the texture analysis unit is configured to detect a highest-frequency line from an edge strength and an edge angle which are obtained from an edge image of the input image, and determine the first direction and the second direction as both directions on the detected highest-frequency line.

30. The image processing apparatus according to claim 28,
wherein the texture analysis unit is configured to detect a high-frequency angle from an edge angle per pixel or region which is obtained from the edge image of the input image, and determine the first direction and the second direction as a direction vertical to the high-frequency angle.

31. The image processing apparatus according to claim 19, further comprising
a region division unit configured to divide a peripheral region of the unnecessary region in the input image into a plurality of regions each being a group of pixels having same or similar features,
wherein the image generation unit is configured to generate a divided reversed image by performing, on the respective regions, processing for reversing at the boundary of the unnecessary region to place, in reverse order, a pixel group in a direction opposite a predetermined direction, the processing being repeated in a direction orthogonal to the predetermined direction, the pixel group consisting of pixels continuously arranged in the predetermined direction, for a predetermined width set in the region of the unnecessary region.

32. The image processing apparatus according to claim 19, further comprising
an image display unit configured to display a result obtained from the image combining unit.

33. An image processing apparatus comprising a display unit configured to receive a touch input from a user, the apparatus comprising:
a first detection unit configured to detect a region, which is identified through a first touch input made in an input image displayed on the display unit, as an unnecessary region in the input image;
a second detection unit configured to detect a second touch input made after the detection of the unnecessary region by the first detection unit, and when the second touch input indicates a movement having a distance greater than or equal to a predetermined value, detect a direction of the movement as the first direction;
an image generation unit configured to generate a first reversed image by performing, on a first region adjacent in the first direction to the unnecessary region, first processing for reversing at a boundary of the unnecessary region to place, in reverse order, a first pixel group in a direction opposite the first direction, the first processing being repeated in a direction orthogonal to the first direction, the first pixel group consisting of pixels continuously arranged in the first direction, for a first width in the first direction in the unnecessary region;
an image combining unit configured to generate a combined image by combining the input image and the first reversed image; and
the display unit configured to display the combined image.

34. An image processing method comprising:
obtaining an input image;
obtaining region information indicating an unnecessary region in the input image;
(i) generating a first reversed image by performing, on a first region adjacent in a first direction to the unnecessary region indicated by the region information, first processing for reversing at a boundary of the unnecessary region to place, in reverse order, a first pixel group in a direction opposite the first direction, the first processing being repeated in a direction orthogonal to the first direction, the first pixel group consisting of pixels continuously arranged in the first direction, for a first width in the first direction in the unnecessary region, and (ii) generating a second reversed image by performing, on a second region adjacent in a second direction to the unnecessary region, second processing for reversing at a boundary of the unnecessary region to place, in reverse order, a second pixel group in a direction opposite the second direction, the second processing being repeated in a direction orthogonal to the second direction, the second pixel group consisting of pixels continuously arranged in the second direction, for a second width in the second direction in the unnecessary region; and
generating a combined image by combining the first reversed image and the second reversed image generated in the generating.

35. A non-transitory computer-readable recording medium for use in a computer, the recording medium having a program recorded thereon for causing the computer to execute the image processing method according to claim 34.

36. An integrated circuit, comprising:
an image obtaining unit configured to obtain an input image;
an obtaining unit configured to obtain region information indicating an unnecessary region in the input image;
an image generation unit configured to (i) generate a first reversed image by performing, on a first region adjacent in a first direction to the unnecessary region indicated by the region information, first processing for reversing at a boundary of the unnecessary region to place, in reverse order, a first pixel group in a direction opposite the first direction, the first processing being repeated in a direction orthogonal to the first direction, the first pixel group consisting of pixels continuously arranged in the first direction, for a first width in the first direction in the unnecessary region, and (ii) generate a second reversed image by performing, on a second region adjacent in a second direction to the unnecessary region, second processing for reversing at a boundary of the unnecessary region to place, in reverse order, a second pixel group in a direction opposite the second direction, the second processing being repeated in a direction orthogonal to the second direction, the second pixel group consisting of pixels continuously arranged in the second direction, for a second width in the second direction in the unnecessary region; and
an image combining unit configured to generate a combined image by combining the first reversed image and the second reversed image which are generated by the image generation unit.
